(19) United States
(12) Patent Application Publication
(10) Pub. No.: US 2006/0163269 A1
(43) Pub. Date: Jul. 27, 2006

(54) Method for loading a medicament dispenser with a medicament carrier

(76) Inventors: Gregor John McLennan Anderson, Ware (GB); Howard Peter Duffield, Ware (GB); Tudor Hugh, Thomas (GB)

Correspondence Address: GLAXOSMITHKLINE;CORPORATE INTELLECTUAL PROPERTY, MAI B475, FIVE MOORE DR., PO BOX 13398, RESEARCH TRIANGLE PARK, NC, 27709-3398, US

(21) Appl. No.: 10/527,606

(22) PCT Filed: Sep. 15, 2003
(86) PCT No.: PCT/EP03/10347

§ 371 Date: Mar. 11, 2005

(30) Foreign Application Priority Data
Sep. 17, 2002 (GB) 0221493.0

(51) Int. Cl. G07F 11/68

(52) U.S. Cl. 221/72

(57) ABSTRACT

There is provided a method of loading a housing for a medicament dispenser with a medicament carrier. The carrier has the form of an elongate strip and has multiple distinct medicament doses carried thereby. The carrier is particularly in the form of a peelable blister strip. In one aspect, the method comprises the steps of loading the housing with at least one leader in the form of an elongate strip such that a leading end of said at least one leader is drivably anchored within the housing and a trailing end of the at least one leader protrudes from the housing; fixing a first end of the medicament carrier to the trailing end of the at least one leader; and drivably moving the leading end of the leader such that the medicament carrier is moved into the housing.

### TECHNICAL FIELD

The present invention relates to a method for loading a medicament dispenser with a medicament carrier. The invention particularly relates to method for loading a mule unit dose medicament dispenser with a medicament carrier in elongate strip form.

### BACKGROUND TO THE INVENTION

The use of medicament dispensers in the administration of medicaments, for example in bronchodilation therapy is well known. Such devices generally comprise a body or housing within which a medicament carrier is located. Known inhalation devices include those in which the medicament carrier is an elongate blister strip containing a number of discrete doses of powdered medicament. In use, the elongate strip is housed within the dispenser in such a way that the strip may be transported through the dispenser in indexed fashion to enable accessing of the discrete doses of medicament carried thereby. Such devices usually contain a mechanism of individually accessing the doses, usually comprising either piercing means or means to peel a lid sheet away from a base sheet. The powdered medicament can then be accessed and inhaled. Such a mechanism may also be used for dispensing medicament in tablet form wherein peeling away the lid sheet from the base sheet reveals a tablet for removal and subsequent consumption.

The efficient loading of an elongate strip form medicament carrier into a medicament dispenser presents numerous problems from a manufacturing assembly standpoint, particularly where such assembly is to be carried out on a high-speed production line. Particular problems include reducing the number and complexity of assembly steps required to introduce the strip into the dispenser; ensuring the correct location of the strip within the dispenser; and ensuring the correct tensioning and transport characteristics of the strip within the dispenser to enable effective indexing and access.

One known method of loading an elongate strip medicament carrier requires the use of either a two-part shell or hinged clamshell form medicament dispenser. Initially, the shell is open to enable the direct placement of the medicament carrier strip therein. At least one end of the carrier strip is then anchored to a drive element (e.g. a drive wheel) within the dispenser which enables the drivable movement thereof. Once the strip is appropriately located, anchored and optionally tensioned, the shell is then closed up to provide the loaded dispenser. Prior to use, it may also be necessary to prime the dispenser such that the medicament carrier strip is transported within the dispenser to an initial dose access position.

In one aspect herein, the Applicant has now devised an alternative to the method described above in which at least one non-medicament carrying strip leader portion is pre-loaded into the dispenser. The leader portion has a simple form such as that of a plain tape or strip (i.e. without surface details and in particular, without blister or other medicament carrying features). The Applicant has also appreciated that such a simple form leader may be introduced into the dispenser in a more straightforward manner than that of a more complex strip form medicament carrier. This in turn, allows for a greater variety of pre-loading methods for introducing the leader portion including those not requiring open-shell form dispensers.

Once the leader is in place within the medicament dispenser, it is then associated with the elongate strip form medicament carrier. Generally, at least one end of the leader strip will be joined (e.g. spliced or adhesively affixed) to an end of the medicament carrier. The leader strip can then be employed to pull the medicament carrier into the dispenser in such a way that it assumes the correct location for dose transport, indexing and access. Again, because direct placement of the medicament carrier strip within the housing is avoided, a greater variety of housing forms may be employed including those defining an essentially closed cavity but defining an access port through which the carrier strip may be guided.

In another aspect, the Applicant has devised a housing that defines a largely closed cavity having an access hatch or door. Any hatch may be provided, typically with an appropriate closure such that after loading of the leader and/or the medicament carrier it may be closed. Snap-fit and other suitable closure mechanisms are envisaged herein. In particular, any door may be suitably hinged such that after loading of the leader and medicament carrier it may be closed shut.

In a further aspect, the Applicant has realized that it can be beneficial to precoil the medicament carrier prior to loading it into the housing of the medicament dispenser. Pre-coiling methods are therefore provided herein, including static and dynamic coiling methods. The pre-coiled medicament carrier may be loaded into the housing as is, or it may be associated with some kind of retaining means designed to retain its coiled form. Suitable retaining means are therefore also provided.

### SUMMARY OF THE INVENTION

According to one aspect of the invention there is provided a method of loading a housing for a medicament dispenser with a medicament carrier, said carrier having the form of an elongate strip and having multiple distinct medicament doses carried thereby, the method comprising

(a) loading said housing with at least one leader in the form of an elongate strip such that a leading end of said at least one leader is drivably anchored within the housing and a trailing end of the at least one leader hangs freely;

(b) fixing a first end of the medicament carrier to said trailing end of the at least one leader;

(c) drivably moving the leading end of the leader such as to move the medicament carrier into the housing.

The method herein is suitable for loading a medicament dispenser with one or more medicament carriers having multiple distinct medicament doses carried thereby.

The medicament dispenser has a housing for receipt of the one or more medicament carriers. In one aspect, the medicament dispenser has unitary form and the housing is integral therewith. In another aspect, the medicament dispenser is configured to receive a refill cassette and the housing forms part of that refill cassette.

The medicament dispenser is shaped to receive one or more elongate strip form medicament carriers. Suitable elongate form medicament carriers are in the form of a strip or tape. The term medicament carrier is used to define any suitable carrier. In a preferred aspect, the carrier has a blister pack form, particularly a blister strip having multiple distinct blister portions provided along its length, but it could also, for example, comprise a carrier onto which medicament has been applied by any suitable process including printing, painting and vacuum occlusion. The medicament carrier has multiple distinct (i.e. separate) medicament doses carried thereby.

In one aspect, the medicament carrier comprises a blister pack in laminate form. Suitably, the laminate comprises material selected from the group consisting of metal foil, organic polymeric material and paper. Suitable metal foils include aluminium or tin foil having a thickness of from 5 to 100 μm, preferably from 10 to 50 μm, such as 20 to 30 μm. Suitable organic polymeric materials include polyethylene, polypropylene, polyvinyl chloride and polyethylene terephthalate.

Access to the medicament dose portions comprised within the pockets of the elongate strip form carrier is by any suitable access means including tearing, piercing or peeling apart the relevant pockets.

One suitable blister pack form medicament carrier comprises a peelable blister strip. Suitably, the peelable blister strip comprises a base sheet in which blisters are formed to define pockets therein for containing distinct medicament dose portions and a lid sheet which is hermetically sealed to the base sheet except in the region of the blisters in such a manner that the lid sheet and the base sheet can be peeled apart. The base and lid sheets are typically sealed to one another over their whole width except for the forward end portions where they are typically not sealed to one another at all. Thus, separate base and lid sheet forward end portions are presented at the end of the strip. The respective base and lid sheets are peelably separable from each other to (e.g. separately) release the contents of each pocket.

Suitably, the lid sheet comprises at least the following successive layers: (a) paper, adhesively bonded to (b) polyester; adhesively bonded to (c) aluminium foil; that is coated with a heat seal lacquer for bonding to the base sheet. The thickness of each layer may be selected according to the desired properties but is typically of the order of from 5 to 200 micron, particularly from 10 to 50 micron.

Suitably, the base sheet comprises at least the following successive layers: (a) oriented polyamide (OPA); adhesively bonded to (b) aluminium foil; adhesively bonded to (c) a third layer comprising a polymeric material (e.g. polyvinyl chloride).

Various known techniques can be employed to join the lid and base sheet and hence to seal the blisters of the peelable blister strip. Such methods include adhesive bonding, hot metal bonding, hot metal welding, radio frequency welding, laser welding, ultrasonic welding and hot bar sealing. The lid sheet and base sheet of the peelable blister strip are particularly sealable by ‘cold form’ sealing methods, which are conducted at lower temperatures than conventional heat sealing methods. Such ‘cold form’ sealing methods are of particular utility where the medicament or medicament formulation for containment within the blister is heat sensitive (e.g. degrades or denatures on heating). Suitable ‘cold form’ sealing methods are conducted at a temperature in the range of 150-250° C., more preferably, 210-240° C.

The medicament dispenser has an internal mechanism for dispensing the distinct medicament doses carried by the medicament carrier for administration to the patient (e.g. by inhalation). Suitably, the mechanism comprises,

a) receiving means for receiving the medicament carrier;

b) release means for releasing a distinct medicament dose from the medicament carrier on receipt thereof by said receiving means;

c) an outlet, positioned to be in communication with the medicament dose releasable by said release means; and

d) indexing means for individually indexing the distinct medicament doses of the medicament carrier.

Where the medicament dispenser is arranged to receive plural elongate form medicament carriers variations of the above mechanism are envisaged, in which each medicament carrier is suitably transported within the dispenser.

The internal mechanism comprises receiving means (e.g. a receiving station) for receiving the or each medicament carrier.

The mechanism further comprises release means for releasing a distinct medicament dose from the or each medicament carrier on its receipt by the receiving station. The release means can have any suitable form. Where the elongate carrier is in the form of a blister strip, the release means may for example, be a means to rupture or otherwise access the blister. In a particular preferred aspect, where the blister strip is peelably accessible, the release means comprises means for peeling apart the blister strip.

An outlet is positioned to be in communication with the distinct medicament doses releasable by said release means. The outlet may have any suitable form. In one aspect, it has the form of a mouthpiece and in another, it has the form of a nozzle for insertion into the nasal cavity of a patient.

The outlet is preferably a single outlet, which communicates with the distinct medicament dose releasable by said release means via a common air channelling means (e.g. formed as an air-pipe or common manifold). The patient may therefore breathe in through a single outlet, and that breath be transferred through the common channelling means to the released medicament dose, thereby enabling its inhalation. Baffles or other mechanical aids to break up released medicament powder may be incorporated. Venturi channelling of the air flow is also envisaged in embodiments. Helical form channels are envisaged.

The internal mechanism also comprises indexing means for individually indexing the distinct medicament doses of the or each medicament carrier. Said indexing typically happens in sequential fashion, for example accessing dose portions sequentially arranged along the length of the elongate carrier.

In one aspect, the method herein comprises in a first step, loading the housing with at least one leader in the form of an elongate strip such that a leading end of said at least one leader is drivably anchored within the housing and a trailing end of the at least one leader hangs freely.

In one aspect herein the trailing end of the at least one leader hangs freely within the housing. In another aspect herein the trailing end protrudes from the housing.

Embodiments are envisaged herein, in which plural leaders are employed. In aspects, plural leaders are employed to interact with different parts of a single elongate form medicament carrier. In other aspects, the medicament carrier is arranged for loading of plural medicament carriers either by the use of single or plural leaders.

In essence, the loading of the leader may be seen in manufacturing terms to be a pre-loading or pre-assembly step since the function of the leader is really to act as a means for more effectively loading the medicament carrier into the housing. Since the leader is elongate in form, it will be appreciated that it typically has a similar characteristics (particularly width) to the medicament carrier and is arranged to interact with any of the internal mechanism features (particularly, drive features) of the housing of the dispenser.

In a particular aspect herein, after loading of the at least one leader (further access to) the housing is temporarily closed off by any suitable closure means. The housing must then be reopened prior to fixing of the medicament carrier to the trailing end of the at least one leader. This aspect is particularly useful when the housing loaded with leader is to be supplied as a pre-assembly.

Embodiments are envisaged in which the pre-assembly is manufactured in one location and supplied as a pre-assembly to a second location for subsequent loading of the medicament carrier.

The leader is elongate and preferably simple in form, most particularly having the form of a plain strip or tape without any further surface detailing along its length. Such simple form aids loading and gives greater flexibility in terms of housing access methods.

The leader is comprised of any suitable material such as a material selected from the group consisting of polymer, paper, metal, fabric and any suitable laminate or composite.

The housing is shaped to enable ease of loading (e.g. by insertion or placement or feeding in) of the leader.

In one aspect, the housing defines a largely closed cavity having an access window, hatch or door. Any hatch may be provided, typically with an appropriate closure such that after loading of the leader and medicament carrier it may be closed. Snap-fit and other suitable closure mechanisms are envisaged herein. In particular, any door may be suitably hinged such that after loading of the leader and medicament carrier it may be closed shut.

A leading end of said at least one leader is drivably anchored within the housing. That is to say, the leading end is anchored directly or indirectly to a drive feature or mechanism of the housing such that it may itself be moved in drivable fashion. The drive feature may have any suitable form including that of a rotatably drivable hub.

The anchoring may be achieved by any suitable means including welding (e.g. heat, ultrasonic or laser), adhesive attachment, stapling, riveting, taping by use of adhesive tape, hook and hole attachment, pin and hole attachment, looping, clamping, knotting, slot and dimple attachment, slot and fold attachment, wrap and sinch attachment and any combination of these. Any anchored join may be cured for additional strength.

In one aspect herein, the leading end of the leader is pre-anchored to a head element, such as a bobbin head element. The pre-anchoring can be achieved by any of the anchoring means described above. The head element is itself shaped for receipt by the housing. In one particular aspect, the head element takes the form of a drive head (e.g. hub form) which on receipt by the housing (e.g. by a spindle element thereof can act as part of a drive mechanism for the leader and (once-loaded) medicament carrier.

After pre-loading, a trailing end of the at least one leader hangs freely either within or without the housing.

In one aspect, the at least one leader protrudes from the housing. The precise length of leader which protrudes from the housing can be varied to suit manufacturing requirements, but it is typically of the order of 5 to 50 cm.

A first end of the medicament carrier is fixed to the trailing end (i.e. that end which hangs freely) of the at least one leader. Any suitable forms of fixing are envisaged including welding (e.g. heat, ultrasonic or laser), adhesive fixing, stapling, adhesive taping, knotting, stitching or cut and folding. Any join may be cured for additional strength.

In one particular aspect herein, the medicament carrier is in the form of a peelable strip. Suitably, the peelable strip comprises a base sheet in which blisters are formed to define pockets therein and a lid sheet which is hermetically sealed to the base sheet except in the region of the blisters in such a manner that the lid sheet and the base sheet can be peeled apart. The base and lid sheets are sealed to one another over their whole width except for the forward end portions where they are typically not sealed to one another at all. Thus, separate base and lid sheet forward end portions are presented.

Where the medicament carrier is a peelable blister strip, a pair of leaders is typically employed, one as a leader for the base sheet and another as a leader for the lid sheet. In this aspect, the leading end of one leader of the pair is anchored to a base sheet drive and the leading end of the other leader of the pair is anchored to a lid sheet drive. Also in this aspect, the trailing end of the base sheet drive-anchored leader is fixed to the base sheet of the medicament carrier and the trailing end of the lid sheet drive-anchored leader is fixed to the lid sheet of the medicament carrier.

To achieve loading of the medicament carrier, the leading end of the leader is moved in drivable fashion such that the medicament carrier is brought into the housing.

Suitably, the medicament carrier experiences a pulling movement which results in it being pulled into the housing. The driving movement of the leader may thus, be arranged to be provided by any suitable means for creating a pulling movement including a winching or winding mechanism such as a rotatable hub. Gearing may be employed as required to ensure appropriate pulling force is transferred.

Suitably, the interior of the housing is shaped, or alternatively provided with specific guiding features, to guide the medicament carrier appropriately into the housing. In particular, the guiding should ensure that the medicament carrier is suitably located to interact with internal mechanisms (e.g. indexing and opening mechanisms) of the housing.

In accord with another aspect of the present invention there is provided a method of pre-coiling an elongate form medicament carrier prior to loading it into the medicament dispenser herein.

The pre-coiling method may be carried out prior to fixing of the medicament carrier to the leader and its loading into the housing. Alternatively, the method of pre-coiling is carried out prior to loading of the medicament carrier into the housing without any use of leaders to guide the medicament carrier into the housing.

Any suitable pre-coiling methods are envisaged including static and dynamic coiling methods.

In a first step of one suitable dynamic pre-coiling method, the leading end of an elongate medicament carrier is received by a spindle (e.g. of diameter from 4 to 8 mm). The receipt typically involves some kind of engagement between spindle and carrier, which may in aspects be frictional or by way of some specific engagement feature provided on the spindle (e.g. a slit for receipt of an end of the carrier). The spindle is both rotatable and movable laterally.

In a second step, the spindle is rotated whilst the strip is kept generally static. A coiled strip thereby results wherein as it forms, the coil is moving generally in a lateral direction. In an alternative second step, the spindle also rotates but the strip is also moved laterally. Overall, the coiled strip thereby moves laterally as it forms. Other coiling methods, which represent variations or intermediate forms of these particular examples, are also envisaged.

The pre-coiled medicament carrier may be loaded as is, or it may be associated with some kind of retaining means designed to retain its coiled form. The retaining means may comprise a simple clip or it may take the form of a cassette housing or part-housing that is shaped for engagement with the housing for the medicament dispenser. In one particular aspect, the retaining means takes the form of a closure for a hatch that is shaped for engagement (e.g. snap-fit) with an access hatch (or window) of the housing for the medicament carrier.

In accord with another aspect of the present invention there is provided a method of loading an elongate form medicament carrier into the medicament dispenser herein, in which coiling of the carrier is carried out in situ (i.e. in the housing of the dispenser) and the shaping of the interior of the housing or of components provided thereto is used to guide the coiling process.

The in situ coiling method is typically carried out when loading a medicament carrier into the housing without any use of leaders to guide the medicament carrier into the housing.

In one aspect, the in situ coiling method is conducted on a housing having an access hatch (or window) through which medicament carrier may be inserted and involves the steps of (i) inserting the carrier through the access hatch; (ii) attachment of the leading end of the carrier to a suitable anchor within the housing; and (iii) in situ coiling of the carrier. The interior of the housing or components provided thereto are shaped to assist and guide the in situ coiling process of the carrier. Other machine tooling (i.e. tooling that does not form part of the dispenser itself) may be provided to the housing to further assist the in situ coiling process.

One advantage of in situ coiling is that the interior of the housing is in effect, acting as an integral ‘machine tool’ to guide the coiling of the carrier, which is efficient from a manufacturing standpoint. Another advantage is that the overall loading method is simplified because there is no separate pre-coiling step.

Suitably, any components used to assist the in situ coiling also have a function within the internal dispensing mechanism of the dispenser (e.g. drive hubs or in use, carrier guidance features such as guide walls or pins). Preferably, the components present a smooth surface to the carrier to avoid snagging during the in situ coiling process.

Suitable speeds of insertion of carrier through the access hatch are in the range from 0.1 to 1.0 metres of carrier/second, preferably from 0.3 to 07 metres of carrier/second.

Optionally, the medicament dispenser also includes counting means for counting each time a distinct medicament dose of the medicament carrier is indexed by said indexing means.

In one aspect, the counting means is arranged to count each time a distinct medicament dose of the medicament carrier is indexed by said indexing means.

Suitably, the indexing means and counting means engage directly or indirectly (e.g. via a coupling) with each other to enable counting of each indexation.

Suitably, the counting means is provided with (or communicates with) a display for displaying to the patient the number of distinct doses left to be taken or the number of doses taken.

In one aspect, the counting means comprises electronic components. Alternatively the counting means comprises mechanical components.

In one aspect, the blister strip has printed numbers on it corresponding to the doses in the pockets and said printed numbers are visible through a window in the dispenser.

In a particular aspect herein, the counting means is provided as a distinct electronic counter unit, which is sized and shaped for receipt by the medicament dispenser (e.g. within a rotatable cover thereof). In one embodiment, the electronic unit is in switching contact with a mechanical arm, which protrudes from the body of the dispenser wherein said arm is coupled to the indexing mechanism such that an indexing action results in switching movement thereof to actuate the electronic counter unit. In another embodiment, the electronic read and display unit comprises a reader capable of reading an analogue count indicium and displaying that indicium in electronic form on a display (e.g. an LCD screen).

In another particular aspect herein, the medicament dispenser is provided with an electronic counter unit incorporating a push-button actuation feature.

In a further particular aspect herein, the medicament dispenser is provided with means to manipulate, and in particular magnify, an analogue count indicium. The means may in one embodiment, comprise the hereinbefore described read-display unit. In another embodiment, the means comprises a prismatic viewer capable of acting on an indicium and causing it to be displayed in manipulated form at a desired viewing position.

Any or all components of the internal mechanism may be driven by either an electronic or mechanical drive system or combination thereof.

Suitably electronic drive means typically comprise a motor, preferably an electrically-powered motor. The motor may provide linear or rotary drive, but in general, rotary motors are most suitable. The motor may for example, comprise a DC electric motor, a piezoelectric (PZ) motor, an ultrasonic motor, a solenoid motor or a linear motor. Preferably, the electronic drive system comprises a DC motor, a PZ motor or an ultrasonic motor.

The use of ultrasonic motors is particularly preferred since they offer advantages over conventional motors in terms of weight, size, noise, cost and torque generated. Ultrasonic motors are well known in the art and are commercially available (e.g. BMSTU Technological Cooperation Centre Ltd, Moscow, Russia; Shinsei Corporation, Tokyo, Japan).

Ultrasonic motors do not use coils or magnets but comprise a piezo-electric ceramic stator which drives a coupled rotor. The stator generates ultrasonic vibrations which in turn causes rotation of the rotor. While regular DC motors are characterised by high speed and low torque, requiring reduction gearing to increase torque, ultrasonic motors attain low speed and high torque, thus eliminating the need for reduction gearing. Furthermore, these motors are lightweight and compact, lacking coils and magnets, and are noiseless as the ultrasonic frequencies used are not audible to the human ear.

Suitably, the dispenser further comprises actuating means for actuating said electronic drive system. Said actuating means may take the form of a switch, push-button, or lever.

In a preferred aspect, the medicament carrier comprises a peelable blister strip having a plurality of pockets for containing medicament wherein said pockets are spaced along the length of and defined between two peelable sheets secured to each other. The respective peelable sheets are generally in the form of a base sheet and a lid sheet of a pocket. In this aspect, the release means comprises peeling means for peeling apart a base sheet and lid sheet to open a pocket. Suitably, the peeling means includes lid-driving means for pulling apart a lid sheet and a base sheet of a pocket that has been received at the opening station.

In one preferred aspect, the medicament dispenser takes the form of a dispenser for use with a medicament carrier having multiple distinct pockets for containing medicament doses, wherein said pockets are spaced along the length of and defined between two peelable sheets secured to each other, said dispenser having an internal mechanism for dispensing the medicament doses contained within said medicament carrier, said mechanism comprising,

a) an opening station for receiving a pocket of the medicament carrier;

b) peeling means positioned to engage a base sheet and a lid sheet of a pocket which has been received in said opening station for peeling apart such a base sheet and lid sheet, to open such a pocket, said peeling means including lid driving means for pulling apart a lid sheet and a base sheet of a pocket that has been received at said opening station;

c) an outlet, positioned to be in communication with an opened pocket through which a user can access a medicament dose from such an opened pocket;

d) indexing means for individually indexing the distinct pockets of the medicament carrier.

Suitably, the indexing means comprises a rotatable index wheel having recesses therein, said index wheel being engageable with a medicament carrier in use with said medicament dispenser such that said recesses each receive a respective pocket of the base sheet of a blister strip in use with said medicament dispenser.

Suitably, the rotatable index wheel additionally comprises a series of indentations located at its base and spaced in-between the recesses.

Suitably, the indexing means additionally comprises an interlock coupling to couple actuation of the dispenser to the index wheel. The interlock coupling reversibly locks the index wheel in place. Preferably, said interlock coupling comprises a foot portion having a toe and a heel, and a tail section. Preferably, said interlock coupling is pivotally mountable to the dispenser at its foot portion. Preferably, said toe fits into one of the indentations on the rotatable index wheel. Preferably, the interlock coupling is sprung to bias it towards location of the toe in one of the indentations.

Alternatively, the indexing means comprises a gear and sprocket wherein teeth on the wheel fit into apertures or holes formed on one or both edges of a medicament carrier. The mechanism therefore resembles that of photographic film being advanced through a camera.

Alternatively, the indexing means comprises an index ratchet which is moveable between a locked position whereby said ratchet engages a pocket on said medicament carrier and prevents further peeling thereof, and a release position allowing free movement of said medicament carrier. In this embodiment, actuation of said medicament dispenser actuates said lid driving means and releases said index ratchet from a medicament carrier to allow peeling thereof.

Suitably, said lid driving means comprises a wheel on which the lid sheet is wound up, said wheel having a winding surface which decreases in diameter when tension in the lid sheet increases. Preferably, said wheel comprises a plurality of resiliently flexible arms each extending therefrom at an angle with respect to a radius. The leading end of the lid sheet is looped over one of said resiliently flexible arms to secure the lid sheet to the wheel initially.

In one aspect, the lid driving means comprise a mangle. The lid sheet passes through two rotating wheels which act as a mangle and is gripped at the point of contact with the wheels. The used portion of the lid sheet is collected in a chamber after it has passed through the mangle.

In another aspect, the lid driving means comprise a roller. Preferably said roller is composed of a polymeric rubber and is positioned next to a guide wall. Preferably said roller has a smooth surface. Alternatively said roller has a knurled surface. The roller grips the lid sheet as it passes from the point at which it is separated from the base sheet through the space between the roller and the guide wall and the used portion of the lid sheet is then collected in a chamber. The roller has the advantage over the mangle described above in that a greater degree of contact between the roller wheel and the lid sheet occurs—the lid sheet is squeezed through the roller and may pass around about ⅓ of the roller wheel. This provides a higher level of grip and pulling force than with a mangle. The force required to turn the roller is constant throughout the use of the device and does not vary according to how much of the lid sheet has been peeled away from the base sheet This is in contrast to the wheel described above where the forces required to turn the wheel may vary due to the fact that the lid sheet is wound around the wheel. The lid sheet is not wound around the roller. The roller also has the advantage that the lid sheet does not have to be looped around or fixed to the roller before use of the device, therefore simplifying assembly of the device and reducing costs.

In a further aspect, the lid driving means comprise a lid spool. The lid spool comprises a toothed wheel with a central upward cylindrical projection on which the lid sheet may be wound when it has been separated from the base sheet The lid spool may have a mechanical gearing mechanism which is driven on actuation of the dispenser; the lid sheet is pulled away from the base sheet and wound onto the lid spool, causing the rotatable indexing wheel to turn and index the base sheet by one dose. An interlock coupling, as described supra, may be moved along the base of the rotatable indexing wheel until it fits into the next base recess. The positioning of the interlock coupling in this recess limits the movement of the lid spool to the distance between two pockets on the base sheet and therefore prevents the amount of lid sheet which is wound around the lid spool from increasing as the diameter of the lid spool is increased.

Suitably, said lid driving means comprises a wheel on which the lid sheet is wound up. Typically, said lid sheet wheel has an effective winding surface, the diameter of which increases after every use of the dispenser as the lid sheet winds around the wheel.

In order to ensure that the same dose is dispensed every time, that is, only a defined number of medicament pocket are opened for every actuation of the dispenser, there may be provided an electronic control system comprising means to limit the extent of movement of said lid driving means, in order to control the length of medicament carrier peeled by said peeling means. Hence, the medicament carrier is indexed by the same amount each time and a uniform, consistent dose is always dispensed.

The dispenser may further comprise compensating means positioned between said opening station and said lid sheet wheel for reducing the length of said lid sheet therebetween to compensate for any increase in the diameter of the effective winding surface of the lid sheet wheel during use of the dispenser.

Typically, the compensating means takes the form of a flexible member. The flexible member may take the form of a flexible elongate arm about which the lid sheet is fed. The arm may flex inwards as tension in the lid sheet increases, and thus shorten the length of lid sheet between the opening station and the lid driving means.

Suitably, the compensating means takes the form of a spring which reduces in length as tension increase in the lid sheet between the opening station and the lid driving means. Typically a piston head is mounted on one end of the spring about which the lid sheet is fed. The other end of the spring may be fixed. As tension in the lid sheet increases the piston is driven down onto the spring.

Suitably, the compensating means takes the form of a sprung-loaded tensioner.

Suitably, the flexible member is resilient so that on removal of tension from the lid sheet, the flexible member will return to its rest position. Thus, the internal mechanism can be reloaded with a new medicament carrier after the used carrier is removed.

Alternatively, or in addition, the dispenser may comprise a clutch means to adjust for any increase in the diameter of the effective winding surface of the lid driving means during use of the dispenser. In one aspect, the clutch means communicates with the indexing means and the lid driving means, and comprises a gearing surface defining plural gear engagement positions; and plural gear teeth for engaging said plural gear engagement positions, wherein the plural gear teeth are arranged such that at any one time only a single gear tooth engages a single gear engagement position.

It will be appreciated that, in use, the clutch means acts to compensate for the increase in diameter of said effective winding surface of the lid driving means. The clutch means allows for slippage when the tension in the lid sheet is greater than the force required to peel apart the lid sheet and the base sheet.

It will be appreciated that in total, the clutch means effectively defines a number of individual gear positions which is greater than the number of gear engagement positions. This is therefore advantageous over a traditional slipping clutch arrangement comprising intermeshing gear wheels, where the effective number of individual gear positions defined is either equal to, or no more than, the number of gear engagement positions defined by one of the gear wheels. The clutch means herein is also typically more compact than traditional slipping clutch arrangements e.g. because it enables smaller gearing surfaces to be employed.

Suitably, the gearing surface and plural gear teeth are arranged such that the number of individual gear positions defined is equal to the number of gear engagement positions multiplied by the number of gear teeth. In one example, if the gearing surface defines 60 gear engagement positions and there are 6 gear teeth, then up to 360 individual gear positions are definable (e.g. 1° resolution on a rotating gearsystem).

Suitably, the gearing surface defines from 20 to 100, preferably from 40 to 80 gear engagement positions. Suitably, the number of gear teeth is from 2 to 20, preferably from 3 to 10.

In one aspect, the gear engagement positions are equally spaced (e.g. equidistantly spaced) and the gear teeth are offset (e.g. non-equidistantly spaced) relative thereto. Such offset arrangement maximises the number of effective individual gear positions which are capable of definition. An example of this aspect, is a Vernier spring arrangement.

In another aspect, the gear engagement positions are also equally spaced (e.g. equidistantly spaced) and the gear teeth are located on a wobbling element capable of wobbling the gear teeth to plural offset (e.g. non-equidistantly spaced) positions. Such a wobbling offset arrangement also maximises the number of effective individual gear positions which are capable of being defined. An example of this aspect, is the wobbling wheel arrangement described herein.

In aspects, the clutch means is non-integral with either of the lid driving means or the indexing means, but forms a separate interconnecting component.

Suitably, the gearing surface comprises a gear wheel. As used herein, the term gear wheel encompasses, for example, a wheel, spindle or spool.

Suitably, the gear teeth may be arranged to be in ratchet form (i.e. enabling movement in one direction only).

Suitably, the gearing surface and gear teeth are in biased (e.g. sprung) engagement.

In one aspect, the lid driving means comprises a spiked wheel. As the spiked wheel turns, the lid sheet is pulled over it and the spikes perforate parts of the lid sheet to improve the grip on the lid sheet. The lid sheet then passes out into a chamber where it collects.

In another aspect, the lid driving means comprises a clamp system. The clamp system comprises at least one angled spring which is pivotable at one end and grips the lid sheet at the other end. The clamp system is moved in the direction that the lid sheet is to be pulled and grips the lid sheet, pulling it and therefore peeling it away from the base sheet. The clamp system is then moved back to its rest position. This results in the spring pivoting and clamping the lid sheet, therefore preventing the lid sheet from being further peeled from the base sheet.

In another aspect, the used portion of the lid sheet may be passed around rollers and fed back onto the used portion of the base sheet after the medicament has been accessed to join back onto the base sheet. The lid sheet may be coated with a sticky substance to aid resealing. The use of this mechanism saves space as the used portions of the blister strip will be collected in the same area.

In another aspect, the coil comprising an unused medicament carrier (e.g. blister strip) may be surrounded by a constant force spring. Alternatively, the coil comprising the unused blister strip may be surrounded by an elastomeric band or band comprising a contractible material. The constant force spring, elastomeric band or band comprising a contractible material contracts as the coil reduces in size.

Suitably, said peeling means additionally comprise a guide for guiding the lid sheet and base sheet along separate paths at the opening station. The lid sheet is passed around the guide portion onto the lid driving means.

Alternatively, the guide comprises a roller mechanism. The lid sheet is fed over the rollers onto the lid driving means.

Suitably, the internal mechanism additionally comprises a first chamber in which at least one strip is initially housed and from which it is dispensed and a second chamber to receive the used portion of the base sheet after it has been indexed around the index wheel and separated from the lid sheet.

Suitably, said first chamber and said second chamber are separated by a wall.

Suitably, said wall is movable to adjust the size of said first and second chambers.

In one aspect, the wall is pivotally mountable. Alternatively the wall is slidably mountable.

Suitably, the internal mechanism further comprises a third chamber to receive the used portion of the lid sheet and a fourth chamber which houses the index ratchet. The fourth chamber may communicate via a slit, which in turn extends upwardly within a mouthpiece and communicates with air inlets.

Suitably, the internal mechanism additionally comprises a crushing wheel to crush the medicament pockets after the medicament has been removed from them. The crushing wheel therefore reduces the space which the used portion of the base sheet takes up.

Typically, the internal mechanism for accessing said medicament contained within said medicament carrier is housed within a cassette.

Thus, in another embodiment, the medicament dispenser for dispensing medicament comprises: a body; a holder, shaped to fit within said body and movable relative to aid body; and receivable by said holder, a cassette housing for containing the medicament carrier.

Suitably, any electronic drive system is located in either the body or the holder part, and the cassette comprises the minimum number of component (i.e. internal mechanism) parts. In embodiments, the body/holder including the electronic drive is designed to be retained by the user and the cassette is sold as a refill/reload component which is discarded after use. By locating the electronic drive system in the body/holder, the amount of electronic components which are discarded is minimised which is advantageous from an environmental standpoint.

Suitably, the cassette of the medicament dispenser herein comprises

a) an opening station for receiving a pocket of the medicament carrier;

b) peeling means positioned to engage a base sheet and a lid sheet of a pocket which has been received in said opening station for peeling apart such a base sheet and lid sheet, to open such a pocket, said peeling means including lid driving means for pulling apart a lid sheet and a base sheet of a pocket that has been received at said opening station;

c) an outlet, positioned to be in communication with an opened pocket through which a user can access a medicament dose from such an opened pocket; and

d) indexing means for individually indexing the distinct pockets of the medicament carrier.

Suitably, movement of the holder relative to the body results in movement of the cassette between a first position and a second position such that the cassette is reversibly removable from the holder when the cassette is in the second position.

Suitably the first position comprises a dispensing position. Preferably the second position comprises a non-dispensing position. The cassette is therefore only removable from the holder when the cassette is in the non-dispensing position.

Suitably, the holder and body include attaching means to attach the holder to the body. Preferably, said attaching means comprise a snap fit mechanism. Suitably said snap fit mechanism comprises a pin and hole system.

Suitably, the holder is pivotally movable relative to the body. Alternatively the holder is rotationally movable relative to the body.

Suitably the holder additionally comprises a stop to limit movement of the holder relative to the body. The stop abuts against the edge of the body at two points when it is rotated. At these points the holder may be designed to click into place. Therefore when the stop abuts one body edge then it is clicked into the dispensing position and when the stop abuts the other body edge then it is clicked into the non-dispensing position.

Alternatively the holder is slidably movable relative to the body.

Suitably, the holder additionally comprises a catch to retain the cassette. The catch may for example comprise a sprung pin which fits into a hole or an integral catch which deforms when pressed allowing removal of the cassette.

Suitably, the catch is child resistant. Child resistance may be realised by having a system which forces the user to perform two actions at once to remove the cassette. Other features of the catch may include shock or impact resistance, the ability to lock the catch and orientation features to ensure that the cassette can only be inserted one way. The catch should also be easy to manufacture and assemble, be robust, be composed of a minimal number of components and intrude minimally into the space into which the cassette is inserted.

Suitably, the holder includes guide means to guide the cassette into the holder. Preferably said guide means comprise guide rails. Alternatively the guide means comprise grooves, indentations or other shaping or surface details to define a ‘lock and key’ relationship between the holder and the cassette. Colour guides, arrows and any other surface markings may also be employed.

Suitably, the cassette additionally comprises means to actuate the dispenser. The actuating means may take the form of a switch, push-button or lever.

Suitably, the cassette additionally comprises a mouthpiece.

Suitably, said mouthpiece is extendable. The mouthpiece extends as the cassette and holder are moved from the non-dispensing position to the dispensing position.

Alternatively the mouthpiece is retractable. The mouthpiece retracts as the cassette and holder are moved from the dispensing position to the non-dispensing position.

In one aspect, the mouthpiece is telescopic. In another aspect, the mouthpiece is fixed.

The medicament dispenser may also be designed for nasal inhalation of a powdered medicament and may therefore incorporate a nosepiece as an alternative to a mouthpiece. If the medicament is in solid form, the dispenser may incorporate an exit channel for tablet release.

Suitably, the body covers the mouthpiece and indexing means (e.g. lever) when the cassette is in the non-dispensing position. This avoids the need for a separate cover and protects the mouthpiece from the ingress of dirt and contaminants during storage;

Suitably, the cassette additionally comprises a raised portion to fit against the holder. The raised portion is located at the opposite end of the cassette to the mouthpiece/nosepiece/exit and indexing lever and prevents the incorrect insertion of the cassette into the holder since it is too wide to fit into the holder. The raised portion is shaped such that it fits against a cut away part of the holder. Preferably said raised portion includes a section which is raised to define a grip portion.

Suitably, at least a portion of the holder and body are shaped for ease of grip by the user.

Suitably, operation of the dispenser may be performed with one hand.

Suitably, the medicament dispenser additionally comprises an electronic data management system. The electronic data management system has input/output capability and comprises a memory for storage of data; a microprocessor for performing operations on said data; and a transmitter for transmitting a signal relating to the data or the outcome of an operation on the data.

Suitably, the electronic data management system is arranged to be responsive to or activated by the voice of a user. Thus, for example the system may be switched on or off in response to a voice command.

The electronic data management system may be integral with the body. Alternatively, the electronic data management system forms part of a base unit which is reversibly associable with the body.

Suitably, the medicament dispenser additionally comprises a data input system for user input of data to the electronic data management system. Preferably, the data input system comprises a man machine interface (MMI) preferably selected from a keypad, voice recognition interface, graphical user interface (GUI) or biometrics interface.

Energy may be conserved by a variety of means to enable the device to operate for longer on a given source of energy, such as a battery. Energy conservation or saving methods have additional advantages in terms of reducing the size requirements of the power source (e.g. battery) and thus the weight and portability of the medicament dispenser.

A variety of energy saving methods is available which generally involve reducing power consumption. One such method is to use a clock or timer circuit to switch the power on and off at regular or predetermined intervals. In another method the system can selectively switch on/off specific electronic devices, such as visual display units or sensors, in order to power these devices only when they are required to perform a particular sequence of events. Thus different electronic devices may be switched on and off at varying intervals and for varying periods under control of the system. The power sequencing system may also respond to a sensor, such as a motion or breath sensor, which is activated on use of the device.

Low power or “micropower” components should be used within the electronics where possible and if a high power device is required for a particular function this should be put into a low power standby mode or switched off when not required. Similar considerations apply in the selection of transducers. Operation at low voltage is desirable since power dissipation generally increases with voltage.

For low power digital applications complementary metal oxide semi-conductor (CMOS) devices are generally preferred and these may be specially selected by screening for low quiescent currents. Clock speeds of processors and other logic circuits should be reduced to the minimum required for computational throughput as power consumption increases with frequency. Supply voltages should also be kept at minimal values consistent with reliable operation because power dissipation in charging internal capacitance's during switching is proportional to the square of the voltage. Where possible, supply voltages should be approximately the same throughout the circuit to prevent current flowing through input protection circuits. Logic inputs should not be left floating and circuits should be arranged so that power consumption is minimised in the most usual logic output state. Slow logic transitions are undesirable because they can result in relatively large class-A currents flowing. Resistors may be incorporated in the power supply to individual devices in order to minimise current in the event of failure.

In some control applications, devices that switch between on and off states are preferred to those that allow analog (e.g. linear) control because less power is dissipated in low resistance on states and low current off states. Where linear components are used (e.g. certain types of voltage regulators) then types with low quiescent currents should be selected. In some circuit configurations it is preferable to use appropriate reactive components (i.e. inductors and capacitors) to reduce power dissipation in resistive components.

Suitably, the system additionally comprises a visual display unit for display of data from the electronic data management system to the user. The display may for example, comprise a screen such as an LED or LCD screen. More preferably the visual display unit is associable with the body of the medicament dispenser.

Suitably, the medicament dispenser additionally comprises a datalink for linking to a local data store to enable communication of data between the local data store and the electronic data management system. The datastore may also comprise data management, data analysis and data communication capability.

The datastore may itself form part of a portable device (e.g. a handheld device) or it may be sized and shaped to be accommodated within the patient's home. The datastore may also comprise a physical storage area for storage of replacement cassettes. The datastore may further comprise a system for refilling medicament from a reservoir of medicament product stored therewithin. The datastore may further comprise an electrical recharging system for recharging any electrical energy store on the medicament dispenser, particularly a battery recharging system.

The datalink may for example enable linking with a docking station, a personal computer, a network computer system or a set-top box by any suitable method including a hard-wired link, an infrared link or any other suitable wireless communications link.

Suitably, the medicament dispenser additionally comprises an actuation detector for detecting actuation of the dispensing mechanism wherein said actuation detector transmits actuation data to the electronic data management system.

The medicament dispenser may additionally comprise a safety mechanism to prevent unintended multiple actuations of the dispensing mechanism. The patient is thereby protected from inadvertently receiving multiple doses of medicament in a situation where they take a number of short rapid breaths. More preferably, the safety mechanism imposes a time delay between successive actuations of the release means. The time delay is typically of the order of from three to thirty seconds.

Suitably, the medicament dispenser additionally comprises a release detector for detecting release of medicament from the cassette, wherein said release detector transmits release data to the electronic data management system.

Suitably, the medicament dispenser additionally comprises a shake detector for detecting shaking of the medicament container (e.g. prior to actuation of the dispensing mechanism), wherein said shake detector transmits shake data to the electronic data management system.

Suitably, any actuation detector, release detector, or shake detector comprises a sensor for detecting any suitable parameter such as movement. Any suitable sensors are envisaged including the use of optical sensors. The release detector may sense any parameter affected by release of the medicament such as pressure, temperature, sound, moisture, carbon dioxide concentration and oxygen concentration.

Suitably, the medicament dispenser additionally comprises a breath trigger for triggering the dispensing mechanism, said breath trigger being actuable in response to a trigger signal from the electronic data management system. Preferably, the electronic data management system includes a predictive algorithm or look-up table for deriving from the breath data when to transmit the trigger signal. For example, a real-time analysis of the patient breath waveform may be made and the trigger point derived by reference to that analysed waveform.

Suitably, the electronic data management system includes a predictive algorithm or look-up table for calculating the optimum amount of medicament to dispense.

Suitably, the memory on the electronic data management system includes a dose memory for storing dosage data and reference is made to the dose memory in calculating the optimum amount of medicament to dispense.

Suitably, the medicament dispenser additionally comprises a selector for selecting the amount of medicament to dispense from said dispensing mechanism. In one aspect, the selector is manually operable. In another aspect, the selector is operable in response to a signal from the transmitter on the electronic data management system.

Suitably, the medicament dispenser comprises in association with a body or housing thereof, a first transceiver for transmitting and receiving data and in association with the medicament container, a second transceiver for transmitting and receiving data, wherein data is transferable in two-way fashion from the first transceiver to the second transceiver. The data is preferably in digital form and suitable for transfer by electronic or optical means.

One advantage of embodiments of this type is the ability to store many types of information in different parts of the memory structure of the transceivers. The information is furthermore stored in a form which is readily and accurately transferable. The information could for example, include manufacturing and distribution compliance information written to the memory at various points in the manufacturing or distribution process, thereby providing a detailed and readily accessible product history of the dispenser. Such product history information may, for example, be referred to in the event of a product recall. The compliance information could, for example, include date and time stamps. The information could also include a unique serial number stored in encrypted form or in a password protectable part of the memory which uniquely identifies the product and therefore may assist in the detection and prevention of counterfeiting. The information could also include basic product information such as the nature of the medicament and dosing information, customer information such as the name of the intended customer, and distribution information such as the intended product destination.

On loading or reloading the medicament dispenser with a cassette the second transceiver may, for example, read the unique serial number, batch code and expiry date of the medicament and any other information on the second transceiver. In this way the nature and concentration of the medicament, together with the number of doses used or remaining within the cassette, may be determined. This information can be displayed to the patient on a visual display unit. Other information, such as the number of times the medicament dispenser has been reloaded with a cassette, may also be displayed.

Similarly, should the cassette be removed from the holder before the supply of medicament is exhausted, the same data can be read from the second transceiver and the number of doses remaining or used determined. Other information, such as the date and time of administration of the drug, or environmental exposure data such as the minimum/maximum temperatures or levels of humidity the cassette has been exposed to, may also be read and displayed to the user.

In the event that the supply of medicament within the container becomes exhausted, or that the shelf life of the medicament has expired, or that the first transceiver does not recognise the batch code on the second transceiver, activation of the dispenser may be prevented to safeguard the user. Activation may also be prevented if the medicament has been exposed to extreme environmental conditions for periods outwith the manufacturer's guidelines.

Data may be transferred to and from any transceiver during the period of use of the medicament dispenser by the patient For example, the medicament dispenser may include an electronic data management system having various sensors associated therewith. Any data collected by the sensors or from any data collection system associated with the electronic data management system including a clock or other date/time recorder is transferable.

Data may be transferred each time the patient uses the device. Or alternatively, data may be stored in a database memory of the electronic data management system and periodically downloaded to any transceiver. In either case, a history of the usage of the device may be built up in the memory of a transceiver.

In one embodiment herein, a history of the usage of the medicament dispenser is transferred to the second transceiver. When the medicament carriers in the cassette are exhausted it is exchanged by the patient for a new refill cassette. At the point of exchange, which will typically occur at the pharmacy, data may be transferred from the exhausted cassette to the refill and vice-versa. Additionally, usage history data may be read from the refill and transferred to a healthcare data management system for example comprising a network computer system under the control of a healthcare data manager.

Methods are envisaged herein whereby the patient is given some sort of reward for returning the refill and making available the data comprised within the second transceiver. Methods are also envisaged herein whereby the healthcare data manager is charged for either receipt of the data from the second transceiver or for its use for commercial purposes. Any rewards or charging may be arranged electronically. The methods may be enabled by distributed or web-based computer network systems in which any collected data is accessible through a hub on the network. The hub may incorporate various security features to ensure patient confidentiality and to allow selective access to information collected dependent upon level of authorisation. The level of user authorisation may be allocated primarily to safeguard patient confidentiality. Beyond this the level of user authorisation may also be allocated on commercial terms with for example broader access to the database being authorised in return for larger commercial payments.

Suitably, the first and second transceiver each comprise an antenna or equivalent for transmitting or receiving data and connecting thereto a memory. The memory will typically comprise an integrated circuit chip. Either transceiver may be configured to have a memory structure which allows for large amounts of information to be stored thereon. The memory structure can be arranged such that parts of the memory are read-only, being programmed during/after manufacture, other parts are read/write and further parts are password protectable. Initial transfer of information (e.g. on manufacture or one dispensing) to or from any transceiver can be arranged to be readily achievable by the use of a reader which is remote from the medicament dispenser, thereby minimising the need for direct product handling. In further aspects, the reader can be arranged to simultaneously read or write to the memory of multiple transceivers on multiple medicament dispensers.

A suitable power source such as a battery, clockwork energy store, solar cell, fuel cell or kinetics-driven cell will be provided as required to any electronic component herein. The power source may be arranged to be rechargeable or reloadable.

Suitably, data is transferable in two-way fashion between the first and second transceiver without the need for direct physical contact therebetween. Preferably, data is transferable wirelessly between the first and second transceiver.

Suitably, the first transceiver is an active transceiver and the second transceiver is a passive transceiver. The term active is used to mean directly-powered and the term passive is used to mean indirectly-powered.

Suitably, the second transceiver comprises a label or tag comprising an antenna for transmitting or receiving energy; and an integrated circuit chip connecting with said antenna, and the first transceiver comprises a reader for said label or tag. In this case the label or tag is a passive transceiver and the reader is an active transceiver. Preferably, the reader will not need to be in direct contact with the tag or label to enable the tag or label to be read.

The tag may be used in combination and/or integrated with other traditional product labelling methods including visual text, machine-readable text, bar codes and dot codes.

Suitably, the integrated circuit chip has a read only memory area, a write only memory area, a read/write memory area or combinations thereof.

Suitably, the integrated circuit chip has a one-time programmable memory area. More preferably, the one-time programmable memory area contains a unique serial number.

Suitably, the integrated circuit chip has a preset memory area containing a factory preset, non-changeable, unique data item. The preset memory item is most preferably in encrypted form.

Suitably, the integrated circuit chip has plural memory areas thereon. Suitably, any memory area is password protected.

Suitably, any memory area contains data in encrypted form. Electronic methods of checking identity, error detection and data transfer may also be employed.

In one aspect, the integrated circuit has plural memory areas thereon including a read only memory area containing a unique serial number, which may for example be embedded at the time of manufacture; a read/write memory area which can be made read only once information has been written thereto; and a password protected memory area containing data in encrypted form which data may be of anti-counterfeiting utility.

Suitably, the tag is on a carrier and the carrier is mountable on the body or holder of the medicament dispenser or on the cassette.

In one aspect, the carrier is a flexible label. In another aspect, the carrier is a rigid disc. In a further aspect, the carrier is a rectangular block. In a further aspect, the carrier is a collar ring suitable for mounting to the neck of an aerosol container. Other shapes of carrier are also envisaged.

Suitably, the carrier is mouldable or weldable to the cassette or housing. Suitably, the carrier encases the tag. More preferably, the carrier forms a hermetic seal for the tag.

In one aspect, the carrier comprises an insulating material such as a glass material or, a paper material or an organic polymeric material such as polypropylene. Alternatively, the carrier comprises a ferrite material.

The energy may be in any suitable form including ultrasonic, infrared, radiofrequency, magnetic, optical and laser form. Any suitable channels may be used to channel the energy including fibre optic channels.

In one aspect, the second transceiver comprises a radiofrequency identifier comprising an antenna for transmitting or receiving radiofrequency energy; and an integrated circuit chip connecting with said antenna, and the first transceiver comprises a reader for said radiofrequency identifier. In this case the radiofrequency identifier is a passive transceiver and the reader is an active transceiver. An advantage of radiofrequency identifier technology is that the reader need not be in direct contact with the radiofrequency identifier tag or label to be read.

The radiofrequency identifier can be any known radiofrequency identifier. Such identifiers are sometimes known as radiofrequency transponders or radiofrequency identification (RFID) tags or labels. Suitable radiofrequency identifiers include those sold by Phillips Semiconductors of the Netherlands under the trade marks Hitag and Icode, those sold by Amtech Systems Corporation of the United States of America under the trade mark Intellitag, and those sold by Texas Instruments of the United States of America under the trade mark Tagit.

Suitably, the antenna of the RFID tag is capable of transmitting or receiving radiofrequency energy having a frequency of from 100 kHz to 2.5 GHz. Preferred operating frequencies are selected from 125 kHz, 13.56 MHz and 2.4 GHz.

In one aspect, the second transceiver comprises a magnetic label or tag comprising an antenna for transmitting or receiving magnetic field energy; and an integrated circuit chip connecting with said antenna, and the first transceiver comprises a reader for said magnetic label or tag. In this case the magnetic label or tag is a passive transceiver and the reader is an active transceiver.

A suitable magnetic label or tag comprises plural magnetic elements in mutual association whereby the magnetic elements move relative to each other in response to an interrogating magnetic field. A magnetic label or tag of this type is described in U.S. Pat. No. 4,940,966. Another suitable magnetic label or tag comprises a magnetorestrictive element which is readable by application of an interrogating alternating magnetic field in the presence of a magnetic bias field which results in resonance of the magnetorestrictive elements at different predetermined frequencies. A magnetic label of this type is described in PCT Patent Application No. WO92/12402. Another suitable magnetic label or tag comprising plural discrete magnetically active regions in a linear array is described in PCT Patent Application No. WO96/31790. Suitable magnetic labels and tags include those making use of Programmable Magnetic Resonance (PMR) (trade name) technology.

In another aspect, the second transceiver comprises a microelectronic memory chip and the first transceiver comprises a reader for said microelectronic memory chip. The microelectronic memory chip may comprise an Electrically Erasable Programmable Read Only Memory (EEPROM) chip or a SIM card-type memory chip. In this case the microelectronic memory chip is a passive transceiver and the reader is an active transceiver.

Any transceiver herein, particularly a passive transceiver may be mounted on or encased within any suitable inert carrier. The carrier may comprise a flexible sheet which may in embodiments be capable of receiving printed text thereon.

In one aspect, the first transceiver is integral with the body such that a single unit is comprised. The first transceiver may for example be encased within or moulded to the body.

In another aspect, the first transceiver forms part of a base unit which is reversibly associable with the body. The base unit may for example, form a module receivable by the body such as a snap-in module.

Suitably, the medicament dispenser additionally comprises a communicator for wireless communication with a network computer system to enable transfer of data between the network computer system and the electronic data management system. Dispensers employing such communicators are described in pending PCT Applications No.s PCT/EP00/09291 (PG3786), PCT/EP00/09293 (PG4029) and PCT/EP00/09292 (PG4159). Preferably, the communicator enables two-way transfer of data between the network computer system and the electronic data management system.

Suitably, the data is communicable between the network computer system and the electronic data management system in encrypted form. All suitable methods of encryption or partial encryption are envisaged. Password protection may also be employed. Suitably, the communicator employs radiofrequency or optical signals.

In one aspect, the communicator communicates via a gateway to the network computer system. In another aspect, the communicator includes a network server (e.g. a web server) such that it may directly communicate with the network.

In a further aspect, the communicator communicates with the gateway via a second communications device. Preferably, the second communications device is a telecommunications device, more preferably a cellular phone or pager. Preferably, the communicator communicates with the second communications device using spread spectrum radiofrequency signals. A suitable spread spectrum protocol is the Bluetooth (trade mark) standard which employs rapid (e.g. 1600 times a second) hopping between plural frequencies (e.g. 79 different frequencies). The protocol may further employ multiple sending of data bits (e.g. sending in triplicate) to reduce interference.

In one aspect, the network computer system comprises a public access network computer system. The Internet is one suitable example of a public access network computer system, wherein the point of access thereto can be any suitable entrypoint including an entrypoint managed by an Internet service provider. The public access network computer system may also form part of a telecommunications system, which may itself be either a traditional copper wire system, a cellular system or an optical network.

In another aspect, the network computer system comprises a private access network computer system. The private access network system may for example, comprise an Intranet or Extranet which may for example, be maintained by a health service provider or medicament manufacturer. The network may for example include password protection; a firewall; and suitable encryption means.

Preferably, the communicator enables communication with a user-specific network address in the network computer system.

The user-specific network address may be selected from the group consisting of a web-site address, an e-mail address and a file transfer protocol address. Preferably, the user-specific network address is accessible to a remote information source such that information from said remote information source can be made available thereto. More preferably, information from the user-specific network address can be made available to the remote information source.

In one aspect, the remote information source is a medicament prescriber, for example a doctors practice. Information transferred from the medicament prescriber may thus, comprise changes to prescription details, automatic prescription updates or training information. Information transferred to the medicament prescriber may comprise compliance information, that is to say information relating to the patient's compliance with a set prescribing programme. Patient performance information relating for example, to patient-collected diagnostic data may also be transferred to the medicament prescriber. Where the dispenser is an inhaler for dispensing medicament for the relief of respiratory disorders examples of such diagnostic data would include breath cycle data or peak flow data.

In another aspect, the remote information source is a pharmacy. Information transferred from the pharmacy may thus, comprise information relating to the medicament product. Information sent to the pharmacy may thus include prescription requests which have been remotely pre-authorised by the medicament prescriber.

In a further aspect, the remote information source is an emergency assistance provider, for example a hospital accident and emergency service or an emergency helpline or switchboard. The information may thus, comprise a distress or emergency assist signal which requests emergency assistance.

In a further aspect, the remote information source is a manufacturer of medicament or medicament delivery systems. Information transferred to the system may thus, comprise product update information. The system may also be configured to feed information back to the manufacturer relating to system performance.

In a further aspect, the remote information source is a research establishment. In a clinical trial situation, information may thus be transferred relating to the trial protocol and information relating to patient compliance fed back to the research establishment.

In a further aspect, the remote information source is an environmental monitoring station. Information relating to weather, pollen counts and pollution levels may thus be made accessible to the system.

Suitably, the medicament dispenser additionally comprises a geographic positioning system such as a global positioning system or a system which relies on the use of multiple communications signals and a triangulation algorithm.

The constituent medicaments of the plural medicament doses suitably, in combination comprise a combination medicament product. Suitably the medicaments are selected from the group consisting of albuterol, salmeterol, fluticasone propionate and beclomethasone dipropionate and salts or solvates thereof. Preferably, the combination comprises salmeterol xinafoate and fluticasone propionate.

The medicament dispenser described above may be provided in kit of parts form. A first part of the kit comprises a body; a holder, shaped to fit within said body and movable relative to said body; and within said holder a receiving station for receipt of a cassette. A second part of the kit comprises a cassette containing a pre-loaded elongate form medicament carrier and an Internal mechanism for indexing said elongate form medicament carrier, wherein the cassette is receivable by the receiving station and movement of the holder relative to the body results in movement of the cassette between a first position and a second position such that the cassette is reversibly removable from the receiving station when the cassette is in the second position. Suitably, the holder also comprises an electronic drive system for driving the internal indexing mechanism of the cassette.

In one aspect, the medicament dispenser may be assembled as follows. The holder is snap fitted into the body. The cassette is assembled separately. The body of the cassette is formed, preferably in two sections with any necessary spindles or integral components formed into the base. Individual components such as indexing wheels, lid winding mechanisms, guide portions etc are then assembled into the base. Finally, the medicament carrier (e.g. blister strip) is inserted into the cassette by a method in accord with the present invention. The medicament carrier may be loaded into the dispenser before a lid is attached to the cassette and the cassette sealed. Alternatively, the cassette may be formed completely apart from a hole left in its side for insertion of the medicament carrier. The hole may then be sealed to complete the cassette. This second method of inserting the medicament carrier into the device has the advantage that it is much simpler from a manufacturing standpoint.

According to another aspect of the present invention there is provided a housing for a medicament dispenser loaded with at least one medicament carrier (and leader strip therefor) and obtainable by the method as described herein.

According to an intermediate assembly method (‘pre-assembly’) aspect of the present invention there is provided a method of loading a housing for a medicament dispenser with at least one leader in the form of an elongate strip, the method comprising loading said housing with at least one leader in the form of an elongate strip such that a leading end of said at least one leader is drivably anchored within the housing and a trailing end of the at least one leader hangs freely for fixing to a medicament carrier, said carrier having the form of an elongate strip and having multiple distinct medicament doses carried thereby

According to an intermediate assembly (‘pre-assembly’) step aspect of the present invention there is provided a housing for a medicament dispenser loaded with leader strip and obtainable by the assembly method as described above.

### BRIEF DESCRIPTION OF THE DRAWINGS

The invention will now be described with reference to the accompanying drawings in which:

FIG. 1 shows a perspective view of a medicament carrier suitable for use in accord with one aspect of the present invention;

FIG. 2 shows in plan view a base unit of a medicament dispenser including an internal mechanism suitable for use in accord with one aspect of the invention;

FIG. 3 shows a perspective view of a medicament dispenser, in the form of a holder/body and a refill cassette with the cassette removed from the holder/body, for use in accord with one aspect of the invention;

FIGS. 4a to 4f show in plan view sequential steps involved in the pre-loading of a leader strip portion and loading of an elongate strip form medicament carrier in accord with one aspect of the invention;

FIGS. 5a and 5b each show a perspective view of a medicament cassette having a hinged access portion for loading of an elongate strip form medicament carrier in accord with alternate aspects of the invention;

FIG. 6 shows a plan view of a spool for receipt of the end of a medicament carrier in accord with one aspect of the invention;

FIGS. 7a and 7b respectively show in perspective view a medicament dispenser having a cut-away access portion and a coiled medicament carrier for receipt thereby in accord with one aspect of the invention;

FIGS. 8a to 8c respectively show methods of coiling a medicament carrier for use in accordance with aspects of the invention; and

FIGS. 9a to 9d show in plan view, and FIG. 9e in perspective view, sequential steps involved in the pre-coiling of an elongate strip form medicament carrier and its loading into a medicament dispenser housing in accord with one aspect of the invention.

### DETAILED DESCRIPTION OF THE DRAWINGS

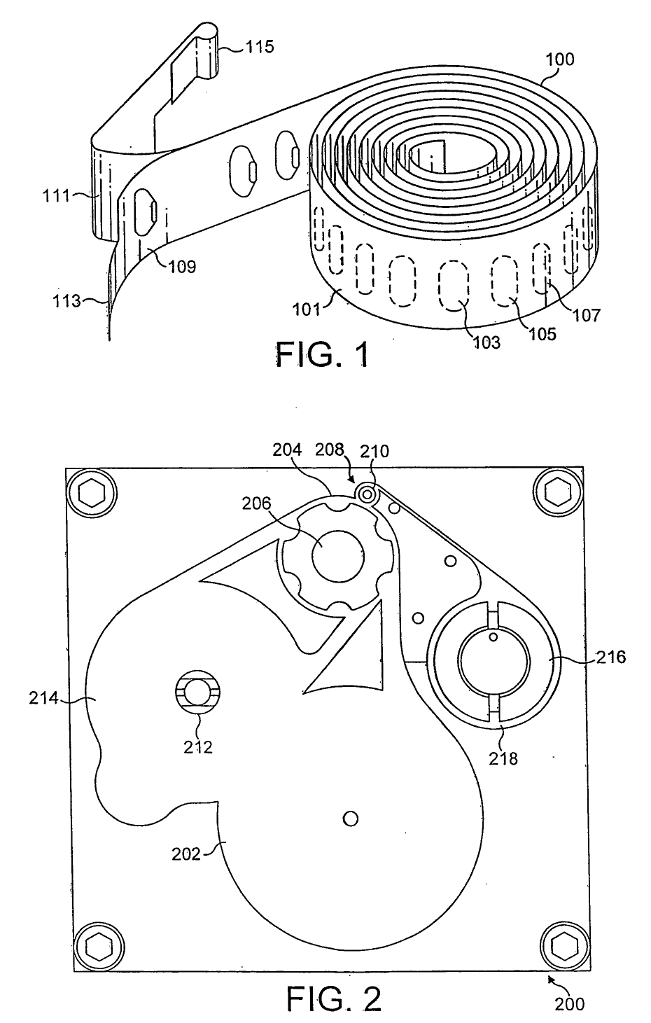

FIG. 1 shows a medicament carrier 100 for use in accord with the present invention. The medicament carrier comprises a flexible strip 101 defining a plurality of pockets 103, 105, 107 each of which would contain a portion of a dose of medicament which can be inhaled, in the form of powder.

The strip comprises a base sheet 109 in which blisters are formed to define the pockets 103, 105, 107 and a lid sheet 111 which is hermetically sealed to the base sheet except in the region of the blisters in such a manner that the lid sheet 111 and the base sheet 109 can be peeled apart The sheets 109, 111 are sealed to one another over their whole width except for the leading end portions 113, 115 where they are preferably not sealed to one another at all.

The lid 111 and base 109 sheets are each formed of a plastics/aluminium laminate and are suitably adhered to one another by heat sealing. The lid sheet 111 comprises at least the following successive layers: (a) paper; adhesively bonded to (b) polyester; adhesively bonded to (c) aluminium foil; that is coated with a heat seal lacquer for bonding to the base sheet. The base sheet 109 comprises at least the following successive layers: (a) oriented polyamide (OPA); adhesively bonded to (b) aluminium foil; adhesively bonded to (c) a third layer comprising a polymeric material (e.g. polyvinyl chloride).

The strip 101 is shown as having elongate pockets 103, 105, and 107 that run transversely with respect to the length of the strip 101. This is convenient in that it enables a large number of pockets 103, 105, 107 to be provided in a given strip 101 length. The strip 101 may, for example, be provided with thirty, sixty or one hundred pockets but it will be understood that the strip 101 may have any suitable number of pockets.

FIG. 2 illustrates a base unit 200 of a medicament dispenser suitable for use in accord with the present invention. A blister strip (not shown for clarity) is positioned in chamber 202 of the base unit 200. The blisters strip are pre-fed through a guide member 204 within the manifold component and engaged in a six-pocket index wheel 206. The first pocket of the blister strip is positioned one pocket away from the opening station 208. The lid foil and base foil are separable about a beak 210. The resulting empty base foil is coiled about a base take-up spindle 212 in the base take-up chamber 214. The used lid foil is fed over the beak 210 and coiled about a lid take-up spindle 216 in the lid take-up chamber 218.

The dispenser is actuated by pressing a button on the side of the dispenser (not shown) to index the internal mechanism by one pocket of medicament. Initially, the gearing between the index wheel 206 and the lid take-up foil spindle 216 is one-to-one. However, as the lid take up spindle 216 winds on more foil, its effective winding diameter increases. An increase in diameter would cause the lid take-up spindle 216 to pull more strip than the index wheel 206 releases.

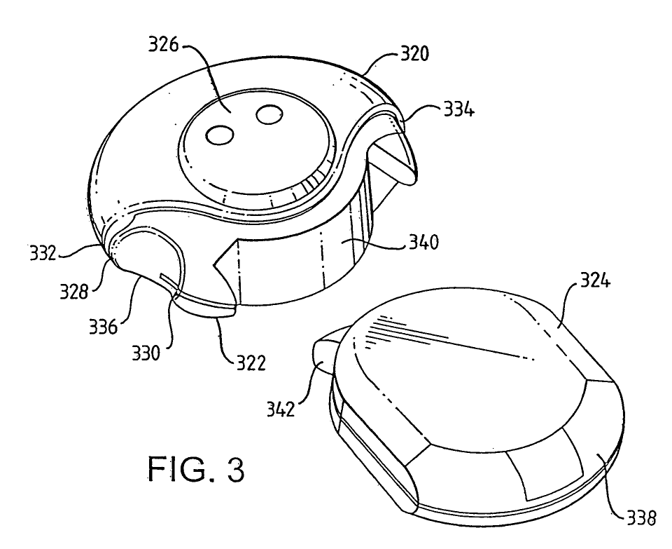

FIG. 3 shows a prior art medicament dispenser of a form suitable for use in accord with the present invention, comprising a body 320, a holder 322, refill cassette 324 and electronic display 326. The holder 322 is shaped to fit snugly inside body 320 and is fixed to a point on the body (not shown) about which it rotates. Stops 328, 330 protrude from the holder 322 and prevent the holder 322 from rotating more than about 180° relative to the body 320. The stops 328, 330 also provide two defined positions of the holder 322 within the body 320. One position is defined by stop 328 meeting with body edge 332 and the other position defined by-stop 330 meeting with body edge 334 when the holder has been rotated relative to the body. The area between stops 328 and 330 is shaped to form a thumb or finger grip 336 for the user of the device. The holder 322 forms a shell into which the refill cassette 304 snugly fits.

The refill cassette 324 comprises a shell containing the plural medicaments carrier (not shown) and a mechanism for opening the carriers (not shown) for the medicament to be accessed. The refill cassette 324 has a raised portion 338 at one end on both sides along its width so that this part of the refill cassette 324 is at least the same depth as the interior part 340 of the holder 322 which receives the refill cassette 324. This allows the position of the cassette 324 within the holder 322 to be fixed such that the ridge 338 protrudes from the holder 322 but the rest of the cassette 324 is contained within the holder 322.

The refill cassette 324 also has a mouthpiece (not shown) and an actuating push button 342 for actuating the device to index the medicament carrier within the cassette 324.

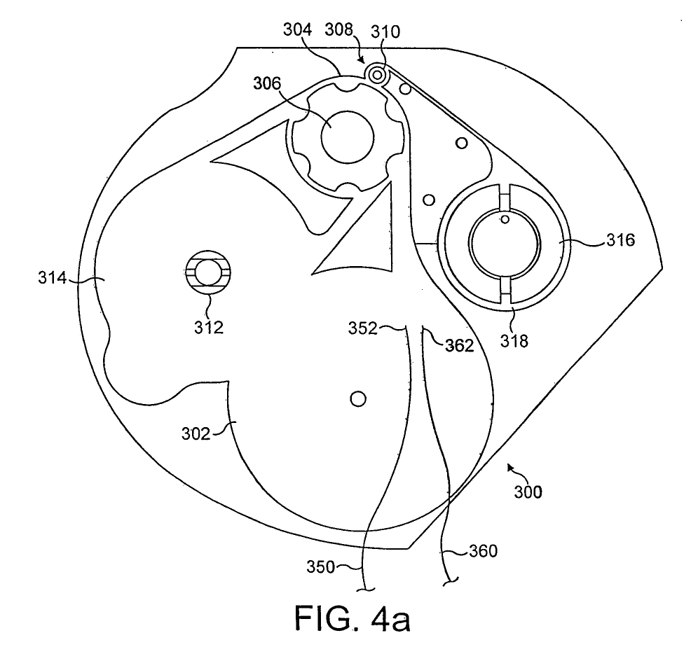

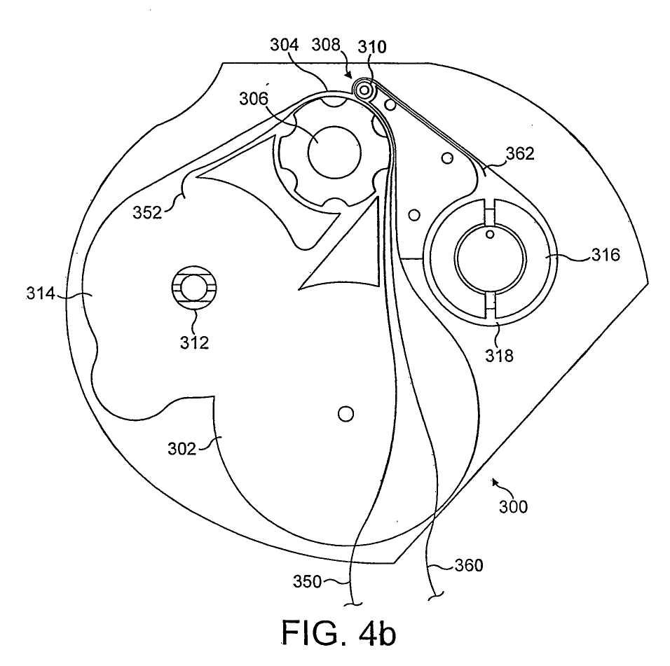

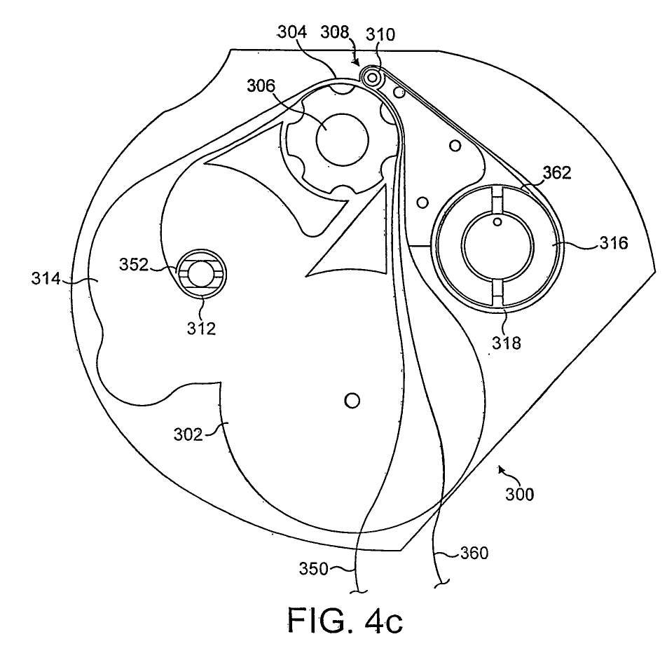

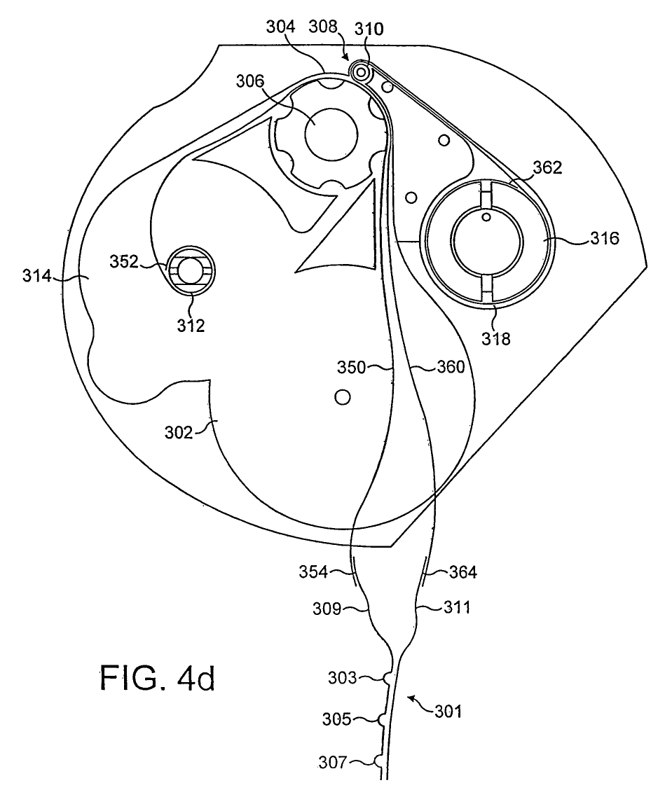

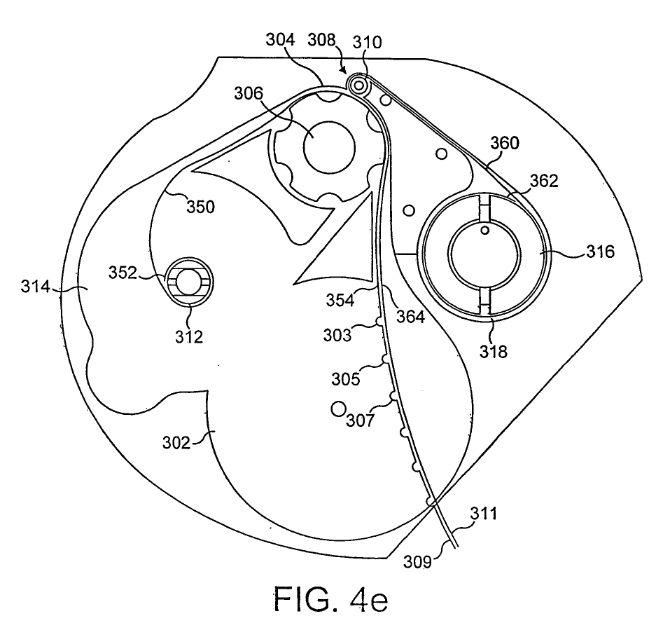

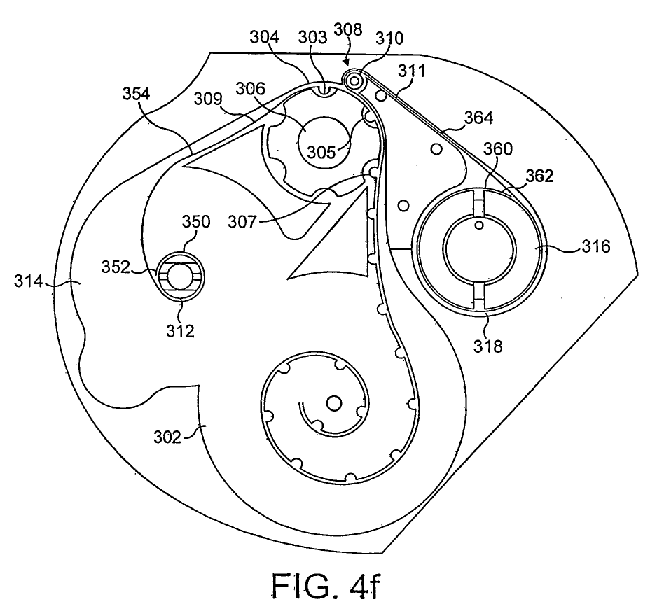

FIGS. 4a to 4f illustrate successive steps involved in loading a base unit housing 300 of a medicament dispenser with a medicament carrier in accord with the present invention. The base unit housing 300 may either be comprised as an integral medicament dispenser as such, or as a refill cassette for a medicament dispenser. The features of the housing 300 are described first followed by the features of the method.

The internal mechanism of the medicament dispenser of FIGS. 4a to 4f is based on that of the dispenser of FIG. 2. A base unit 300 includes chamber 302 for receipt of an elongate medicament carrier in the form of a blister strip. The received blister strip is pre-fed through a guide member 304 within the manifold component and engaged in a six-pocket index wheel 306. Opening of pockets of the blister strip is configured to occur at the opening station 308. In dispensing use, the lid foil and base foil are separable about a beak 310. The resulting empty base foil is coiled about a base take-up spindle 312 in the base take-up chamber 314. The used lid foil is fed over the beak 310 and coiled about a lid take-up spindle 316 in the lid take-up chamber 318.

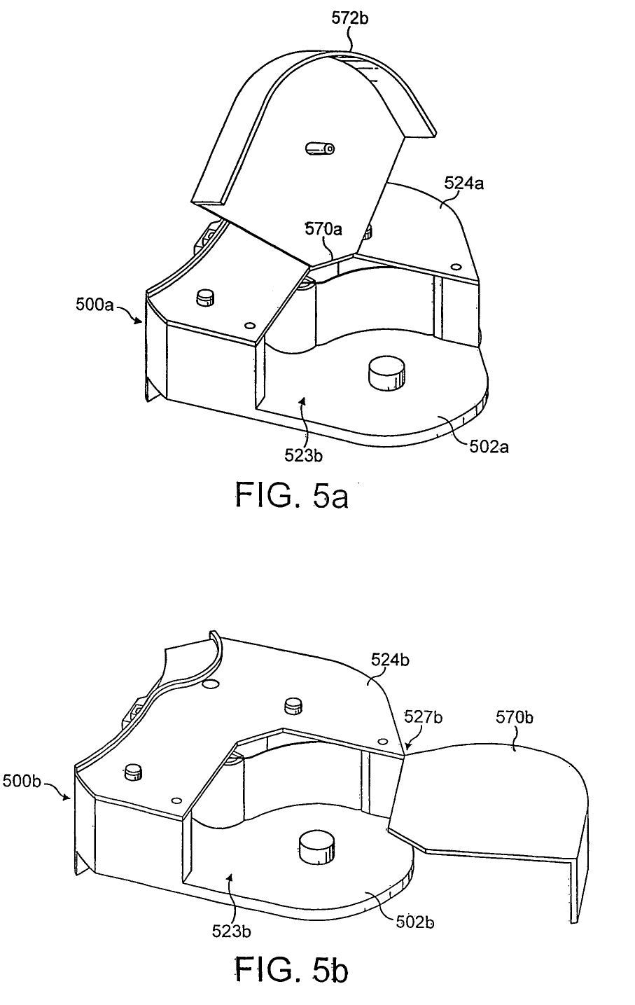

Turning to now the loading method aspects, in FIG. 4a two leader strips 350, 360, each comprising a plain tape formed of plastic polymer, paper, metal, fabric or a laminate are introduced to the base unit 300 via the chamber 302. Access to the chamber may be provided in a variety of ways, particularly as illustrated in FIGS. 5a and 5b. It may be seen that the leading ends 352, 362 of each respective leader strip are directed towards the opening mechanism 304, 306, 308 of the dispenser 300. In FIG. 4b, those leading ends 352, 362 have been received within different parts of the opening mechanism 304, 306, 308. In more detail, the first leader strip 350 is directed around the index wheel 306 and its leading end 352 guided towards the base take-up chamber 314. The second leader strip 360 is directed around the beak 310 and its leading end 362 guided towards the lid take-up chamber 318. In FIG. 4c, the respective leading ends 352, 362 of the leader strips 350, 360 are secured to the base take-up spindle 316 and lid take-up spindle 318. The leader strips 350, 360 may now thus, be transported through the dispenser 300 by respective rotation of the relevant take-up spindles 316, 318 in much the same way that a medicament carrier would be transported through the dispenser in use (e.g. as described previously in relation to the dispenser of FIG. 2).

In manufacturing aspects, the leader strip threaded ‘product’ of the method steps shown in FIGS. 4a to 4c may be regarded as a sub-assembly. In one aspect herein, this sub-assembly may be manufactured at a site that is distinct, and potentially geographically distant, from the site at which the subsequent steps of FIGS. 4d to 4f (described below) are conducted.

It will have been appreciated from the above that the first leader strip 350 of the sub-assembly is designed to function as a leader for a base sheet, and the second leader strip 360 as a leader for a lid sheet, wherein the medicament carrier has the general form of that shown in FIG. 1.

In FIG. 4d, the trailing end 354 of the first leader strip 350 is fixed to the base sheet 309 and the trailing end 364 of the second leader strip 360 is fixed to the lid sheet 311 of an elongate form blister strip 301. The fixing may be achieved by any suitable means including adhesive and welding methods. It will now be appreciated that the respective leader strips 350, 360 may be employed to ‘lead’ the blister strip into the internal mechanism 304, 306, 308 of the dispenser. Thus, in FIG. 4e the leader strips 350, 360 have been advanced by rotation of the respective take-up spindles 316, 318 and the blister strip 301 thereby drawn into the dispenser 300.

In FIG. 4f, the blister strip has been further drawn in such that the first three blisters 303, 305 and 307 are received by the six-pocket index wheel 306. Indeed, the first blister 303 is open as result off the peeling off of the lid sheet 309 around the beak 310 at the opening station. FIG. 4f thus, may correspond to a first dispensing position, although more often the first blister is not filled with medicament such that FIG. 4f would correspond to a primed ‘false start’ position. Importantly, In the position shown in FIG. 4f the leading end of the base sheet 309 and lid sheet 311 are received by the respective base sheet and lid sheet take-up spindles 316, 318. The spindle drive action thus, acts on the directly on the base sheet 309 and lid sheet 311 to enable the further driving of the strip 301 through the dispenser 300 for dispensing of medicament from the blisters 305, 307.

FIGS. 5a and 5b show alternative means of enabling access to the interior 523a, 523b of the housing 524a, 524b of a medicament dispenser cassette 500a, 500b to enable the receipt of leader strip(s) and medicament carrier(s) by the strip-receiving chamber 502a, 502b thereof.

In FIG. 5a, the housing 524a of the cassette 500a is provided with a top-opening door 570a hinged at hinged point 572a. Once leader and medicament carrier strip (not shown) has been appropriately inserted the door 570a is closed and typically sealed to provide a secure enclosure for the medicament carrier. In FIG. 5b, the housing 524b of the cassette 500b is similarly provided with a side-opening door 570b hinged at hinge point 572b.

FIG. 6 shows the form of a bobbin 580 suitable for attachment to the leading end 652 of a leader strip 650 herein. The bobbin 580 may be seen to comprise circumferential slits 682, 684 for receipt of strip 650 and spindle mounting head 686, which is shaped for co-operation with, or in other aspects lo replace, a spindle (e.g. a lid or base sheet take-up spindle 216, 218 as shown in FIG. 2). The bobbin 580 is employed in aspects herein whereby in a pre-step, the leader strip 650 is associated with the bobbin 680 by receipt of its leading end 652 in slit 682 and the bobbin-headed leader strip assembly 650, 680 then introduced into a dispenser. In these aspects, it will be appreciated that the ‘lead’ function is performed by the bobbin-headed leader strip assembly 650, 680 rather than just by a leader strip 650 alone.

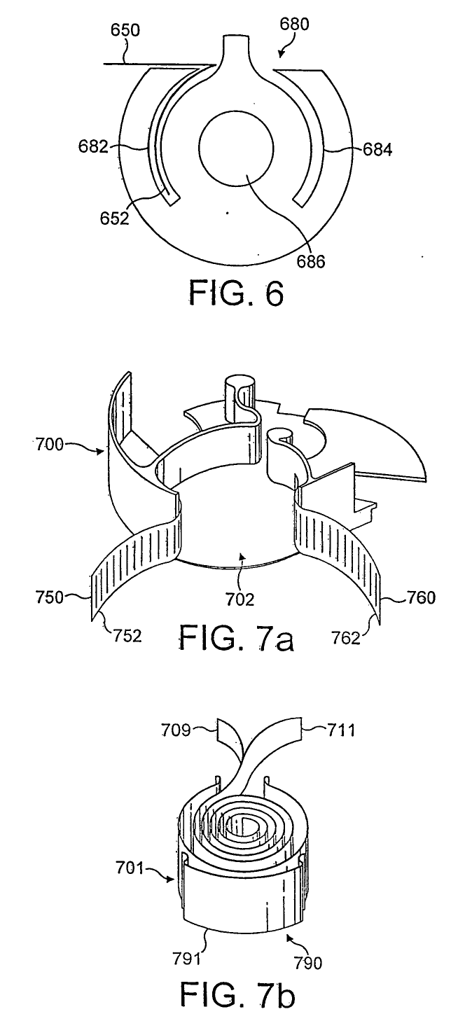

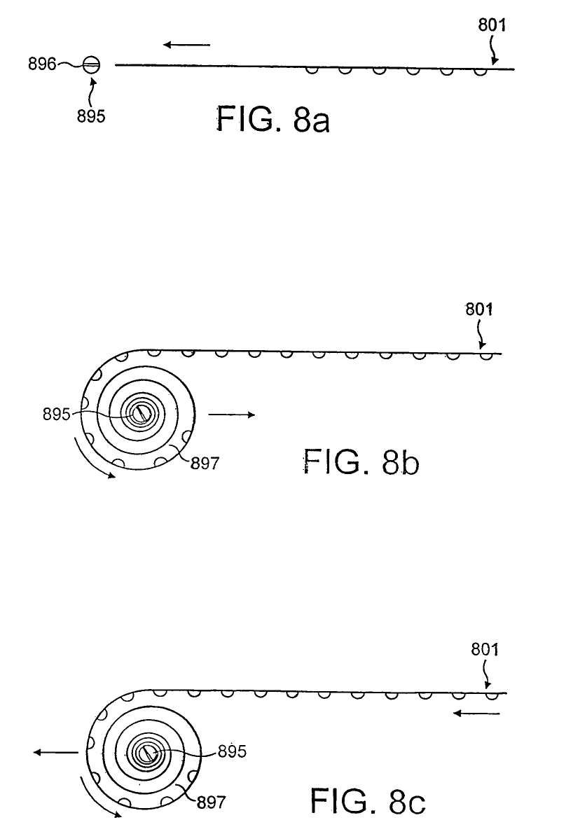

FIGS. 7a and 7b illustrate a development of the loading method herein in which a dispenser 700 which has been pre-loaded with leader strip 750, 760 (e.g. as shown in the steps illustrated in FIGS. 4a to 4c) is associated with a pre-coiled blister strip 701 medicament carrier comprised within a clip-form cassette 790. The pre-coiling of the blister strip 701 may be conducted by any suitable method including those shown in FIGS. 8a to 8c below. The base sheet 709 and lid sheet 711 of the blister strip 701 protrude from the clip-form cassette 790 and are arranged for easy fixing to the relevant ends 752, 762 of the leader strip 750, 760. As in previous examples, once so fixed the blister strip 701 may be readily drawn into the dispenser by the action of the leader strips 750, 760. The clip-form cassette 790 is arranged for snap-fit engagement with the dispenser 700 such that when engaged a wall 791 of the cassette forms part of the dispenser housing. It will also be appreciated that when so engaged, the blister strip 701 is generally received in the strip-receiving chamber 702 of the dispenser housing 700 from which it may be readily drawn in by action of the leaders 750, 760.

FIGS. 8a to 8c generally show blister strip 801 coiling methods herein. A pre-coiling step may be conducted prior to fixing of the blister strip to leader strip. Additionally, any pre-coiling may be followed by a step where the coiled blister strip is introduced into a cassette, such as the simple clip-form cassette 790 of FIGS. 7a and 7b.

In FIG. 8a, the leading end of a blister strip 801 is received by a spindle 895 having a slit 896 provided therein. The spindle 895 is both rotatable and movable on a horizontal axis. In a first alternative shown in FIG. 8b, the spindle 895 is rotated anti-clockwise whilst the strip 801 is kept generally static. A coiled strip 897 thereby results wherein the coil 897 is moving generally in a left to right direction, as shown. In a second alternative, shown in FIG. 8c the spindle 895 also rotates anti-clockwise but the strip 801 is moved in a right to left direction. Overall, the coiled strip 897 thereby moves in a right to left direction. Other coiling methods, which represent variations of these particular examples are also envisaged.

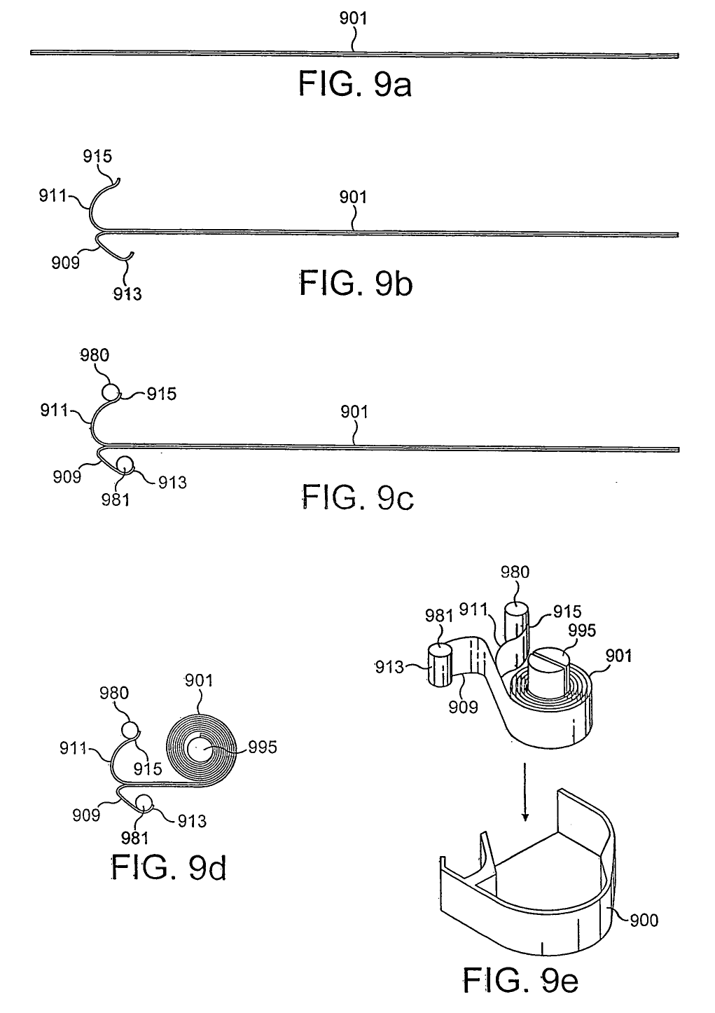

FIGS. 9a to 9e show the sequential steps involved in one method of pre-coiling an elongate strip form medicament carrier and loading it into the housing of a medicament dispenser.

In FIG. 9a, an elongate form medicament carrier 901 is first cut to length. The medicament carrier 901 has the general flexible strip form of that carrier shown in FIG. 1. Pockets for containing medicament are arranged in series along its length, although for simplicity of representation these are not shown in FIGS. 9a to 9e.

In FIG. 9b, the leading ends 913, 915 of the base sheet 909 and lid sheet 911 of he medicament carrier strip are peeled apart. In FIG. 9c, bobbins 980, 981 are respectively attached to those leading ends 913, 915. The medicament carrier strip 901 is then coiled around a spindle 995, as shown in FIG. 9d, by a suitable coiling method such as the dynamic coiling method of FIGS. 8a to 8c.

In FIG. 9e, the pre-coiled strip 901 and bobbin 980, 981 assembly is loaded into a suitable medicament dispenser housing 900 by placement therein. It will be appreciated that within the housing 900 the bobbin-headed leading ends 913, 915 will then be associated with suitable base sheet and lid sheet anchors (e.g. as shown in FIG. 2) for drivable peeling of the strip 901, in use.

It may be appreciated that any of the parts of the device or any medicament thereof which contacts medicament may be coated with materials such as fluoropolymer materials (e.g. PTFE or FEP) which reduce the tendency of medicament to adhere thereto. Any movable parts may also have coatings applied thereto which enhance their desired movement characteristics. Frictional coatings may therefore be applied to enhance frictional contact and lubricants (e.g. silicone oil) used to reduce frictional contact as necessary.

The device of the invention is suitable for dispensing medicament products particularly for the treatment of respiratory disorders such as asthma and chronic obstructive pulmonary disease (COPD), bronchitis and chest infections.

Appropriate medicaments may thus be selected from, for example, analgesics, e.g., codeine, dihydromorphine, ergotamine, fentanyl or morphine; anginal preparations, e.g., diltiazem; antiallergics, e.g., cromoglycate (e.g. as the sodium salt), ketotifen or nedocromil (e.g. as the sodium salt); antiinfectives e.g., cephalosporins, penicillins, streptomycin, sulphonamides, tetracyclines and pentamidine; antihistamines, e.g., methapyrilene; anti-inflammatories, e.g., beclomethasone (e.g. as the dipropionate ester), fluticasone (e.g. as the propionate ester), flunisolide, budesonide, rofleponide, mometasone e.g. as the furoate ester), ciclesonide, triamcinolone (e.g. as the acetonide) or 6α,9α-difluoro-11β-hydroxy-16α-methyl-3-oxo-17α-propionyloxy-androsta-1,4-diene-17β-carbothioic acid S-(2-oxo-tetrahydro-furan-3-yl) ester; antitussives, e.g., noscapine; bronchodilators, e.g., albuterol (e.g. as free base or sulphate), salmeterol (e.g. as xinafoate), ephedrine, adrenaline, fenoterol (e.g. as hydrobromide), formoterol (e.g. as fumarate), isoprenaline, metaproterenol, phenylephrine, phenylpropanolamine, pirbuterol (e.g. as acetate), reproterol (e.g. as hydrochloride), rimiterol, terbutaline (e.g. as sulphate), isoetharine, tulobuterol or 4-hydroxy-7-[2-[[2-[[3-(2-phenylethoxy)propyl]sulfonyl]ethyl]amino]ethyl-2(3H)-benzothiazolone; adenosine 2a agonists, e.g. 2R,3R,4S,5R)-2-[6-Amino-2-(1S-hydroxymethyl-2-phenyl-ethylamino)-purin-9-yl]-5-(2-ethyl-2H-tetrazol-5yl)-tetrahydro-furan-3,4-diol (e.g. as maleate); α₄ integrin inhibitors e.g. (2S)-3-[4-({[4-(aminocarbonyl)-1-piperidinyl]carbonyl}oxy)phenyl]-2-[((2S)-4-methyl-2-{[2-(2-methylphenoxy)acetyl]amino}pentanoyl)amino]propanoic acid (e.g. as free acid or potassium salt), diuretics, e.g., amiloride; anticholinergics, e.g., ipratropium (e.g. as bromide), tiotropium, atropine or oxitropium; hormones, e.g., cortisone, hydrocortisone or prednisolone; xanthines, e.g., aminophylline, choline theophyllinate, lysine theophyllinate or theophylline; therapeutic proteins and peptides, e.g., insulin or glucagon; vaccines, diagnostics, and gene therapies. It will be clear to a person skilled in the art that, where appropriate, the medicaments may be used in the form of salts, (e.g., as alkali metal or amine salts or as acid addition salts) or as esters (e.g., lower alkyl esters) or as solvates (e.g., hydrates) to optimise the activity and/or stability of the medicament.

In one aspect, preferred medicaments are selected from albuterol, salmeterol, fluticasone propionate and beclomethasone dipropionate and salts or solvates thereof, e.g., the sulphate of albuterol and the xinafoate of salmeterol.

In one aspect, the medicament dispenser device herein is suitable for dispensing medicament combination products. Preferred components of combinations of active ingredients contain a bronchodilator In combination with an anti-inflammatory. The bronchodilator is suitably a beta-agonist, particularly a long-acting beta-agonist (LABA). Suitable bronchodilators include salbutamol (e.g., as the free base or the sulphate salt), salmeterol (e.g., as the xinafoate salt) and formoterol (eg as the fumarate salt). The anti-inflammatory is suitably an anti-inflammatory steroid. Suitably anti-inflammatory compounds include a beclomethasone ester (e.g., the dipropionate), a fluticasone ester (e.g., the propionate) or budesonide or any salt or solvate thereof. One preferred combination of components comprises fluticasone propionate and salmeterol, or any salt or solvate thereof (particularly the xinafoate salt). A further combination of components of particular interest is budesonide and formoterol or any salt or solvate thereof (e.g. formoterol as the fumarate salt).

Generally, powdered medicament particles suitable for delivery to the bronchial or alveolar region of the lung have an aerodynamic diameter of less than 10 micrometers, preferably less than 6 micrometers. Other sized particles may be used if delivery to other portions of the respiratory tract is desired, such as the nasal cavity, mouth or throat. The medicament may be delivered as pure drug, but more appropriately, it is preferred that medicaments are delivered together with excipients (carriers) which are suitable for inhalation. Suitable excipients include organic excipients such as polysaccharides (i.e. starch, cellulose and the like), lactose, glucose, mannitol, amino acids, and maltodextrins, and inorganic excipients such as calcium carbonate or sodium chloride. Lactose is a preferred excipient.

Particles of powdered medicament and/or excipient may be produced by conventional techniques, for example by micronisation, milling or sieving. Additionally, medicament and/or excipient powders may be engineered with particular densities, size ranges, or characteristics. Particles may comprise active agents, surfactants, wall forming materials, or other components considered desirable by those of ordinary skill.

The excipient may be included with the medicament via well-known methods, such as by admixing, co-precipitating and the like. Blends of excipients and drugs are typically formulated to allow the precise metering and dispersion of the blend into doses. A standard blend, for example, contains 13000 micrograms lactose mixed with 50 micrograms drug, yielding an excipient to drug ratio of 260:1. Dosage blends with excipient to drug ratios of from 100:1 to 1:1 may be used. At very low ratios of excipient to drug, however, the drug dose reproducibility may become more variable.

The dispenser device herein is in one aspect suitable for dispensing medicament for the treatment of respiratory disorders such as disorders of the lungs and bronchial tracts including asthma and chronic obstructive pulmonary disorder (COPD). In another aspect, the invention is suitable for-dispensing medicament for the treatment of a condition requiring treatment by the systemic circulation of medicament, for example migraine, diabetes, pain relief e.g. inhaled morphine.

Accordingly, there is provided the use of a dispenser device herein for the treatment of a respiratory disorder, such as asthma and COPD. Alternatively, there is provided a method of treating a respiratory disorder such as, for example, asthma and COPD, which comprises administration by inhalation of an effective amount of medicament product as herein described from a device of the present invention.

It will be understood that the present disclosure is for the purpose of illustration only and the invention extends to modifications, variations and improvements thereto.

The application of which this description and claims form part may be used as a basis for priority in respect of any subsequent application. The claims of such subsequent application may be directed to any feature or combination of features described therein. They may take the form of product, method or use claims and may include, by way of example and without limitation, one or more of the following claims:

1. A method of loading a housing for a medicament dispenser with a medicament carrier, said carrier having the form of an elongate strip and having multiple distinct medicament doses carried thereby, the method comprising
(a) loading said housing with at least one leader in the form of an elongate strip such that a leading end of said at least one leader is drivably anchored within the housing and a trailing end of the at least one leader hangs freely;
(b) fixing a first end of the medicament carrier to said trailing end of the at least one leader;
(c) drivably moving the leading end of the leader such as to move the medicament carrier into the housing.

2. A method according to claim 1, wherein the medicament carrier has blister pack form.

3. A method according to claim 1, wherein the at least one leader is in the form of a plain elongate strip without any particular surface detailing along its length.

4. A method according to claim 1, wherein the width of the at least one leader strip matches that of the medicament carrier strip.

5. A method according to claim 1, wherein the at least one leader has a length of from 5 to 50 cm.

6. A method according to claim 1, wherein the at least one leader comprises a material selected from the group consisting of polymer, paper, metal, fabric, laminate and composite.

7. A method according to claim 1, wherein the at least one leader anchors to a rotatable drive hub in the housing.

8. A method according to claim 1, wherein the leading end of at least one leader has a bobbin provided thereto.

9. A method according to claim 8, wherein the bobbin is arranged for drivable anchoring within the housing.

10. A method according to claim 9, wherein the bobbin takes the form of a drive head, which on anchoring within the housing acts as part of a drive mechanism for the at least one leader.

11. A method according to claim 1, wherein anchoring of the leader within the housing is by a method selected from the group consisting of heat welding, ultrasonic welding, laser welding, adhesive fixing, stapling, riveting, taping, hook and hole fixing, pin and hole fixing, looping, clamping, knotting, slot and dimple fixing, slot and fold fixing, wrap and cinch fixing and any combination thereof.

12. A method according to claim 1, wherein in step (a) the trailing end of the at least one leader hangs freely within the housing.

13. A method according to claim 1, wherein in step (a) the trailing end of the at least one leader protrudes from the housing.

14. A method according to claim 1, wherein fixing step (b) is by a fixing method selected from the group consisting of heat welding, ultrasonic welding, laser welding, adhesive fixing, stapling, adhesive taping, knotting, stitching, cut and folding and any combination thereof.

15. A method according to claim 1, wherein drivable movement step (c) is responsive to actuation of a geared drive mechanism provided to the housing.

16. A method according to claim 1, additionally comprising closing off the housing subsequent to movement of the medicament carrier there into.

17. A method according to claim 1, wherein the housing defines a cavity having an access port with a closure provided thereto.

18. A method according to claim 1, wherein the medicament carrier is in the form of a peelable strip comprising a base sheet, in which blisters are formed to define pockets therein and a lid sheet which is hermetically sealed to the base sheet except in the region of the blisters in such a manner that the lid sheet and the base sheet can be peeled apart and except in the region of the forward end portions such that separate base and lid sheet forward end portions are presented.

19. A method according to claim 18, wherein a first leader is employed for the base sheet of the peelable strip and a second leader is employed for the lid sheet of the peelable strip.

20. A method according to claim 19, wherein the leading end of said first leader anchors to a base sheet drive and/or the leading end of said second leader anchors to a lid sheet drive.

21. A method according to claim 19, wherein in step (b) the trailing end of the first leader is fixed to the base sheet of the medicament carrier and the trailing end of the second leader is fixed to the lid sheet of the medicament carrier.

22. A method according to claim 1, wherein the medicament carrier is coiled up prior to fixing to the at least one leader.

23. A method according to claim 22, wherein coiled up medicament carrier is associated with retaining means for retaining the coiled form thereof.

24. A method according to claim 23, wherein said retaining means has the form of a clip.

25. A method according to claim 23, wherein said retaining means has a form arranged for engagement with the housing on movement of the coiled up medicament carrier into the housing.

26. A method according to claim 25, wherein the retaining means has the form of a closure for an access port of the housing.

27. A method according to claim 1, wherein the medicament carrier is coiled up subsequent to fixing to the at least one leader.

28. A method according to claim 27, wherein the medicament carrier is coiled by in situ coiling within the housing.

29. Medicament dispenser loaded with a medicament carrier and at least one leader therefor obtainable by the method of claim 1.

30. A method for making a pre-assembly for use with the method of claim 1 the pre-assembly method comprising loading a housing for a medicament dispenser with at least one leader in the form of an elongate strip such that a leading end of said at least one leader is drivably anchored within the housing and a trailing end of the at least one leader hangs freely for fixing to a medicament carrier, said carrier having the form of an elongate strip and having multiple distinct medicament doses carried thereby.

31. A pre-assembly method according to claim 30, additionally comprising closing off the housing to contain the at least one leader therein.

32. Pre-assembly obtainable by the method according to claim 30.

33. A housing for a medicament dispenser arranged for loading with a medicament carrier by a method according to claim 1, said carrier having the form of an elongate strip and having multiple distinct medicament doses carried thereby, said housing comprising
(a) a body defining a cavity having an access port for receipt of a medicament carrier provided thereto; and
(b) a closure provided to said access port.

34. A housing according to claim 33, wherein said closure comprises a door in hinged relationship with said body.

35. A method of coiling a medicament carrier, said carrier having the form of an elongate strip and having multiple distinct medicament doses carried thereby, the method comprising
(a) receiving the leading end of the elongate medicament carrier by a spindle;
(b) rotating said spindle whilst keeping the elongate medicament carrier generally static.

36. A method of coiling a medicament carrier, said carrier having the form of an elongate strip and having multiple distinct medicament doses carried thereby, the method comprising
(a) receiving the leading end of the elongate medicament carrier by a spindle;
(b) rotating said spindle whilst keeping moving the elongate medicament carrier in a lateral sense.

37. A method of coiling according to claim 35, wherein the spindle frictionally engages the elongate medicament carrier.

38. A method of coiling according to claim 35, wherein the end of the elongate medicament carrier is received within a slit provided to the spindle.

39. Coiled medicament carrier obtainable by a method according to claim 34.

40. A method of loading a housing for a medicament dispenser with a coiled medicament carrier, said carrier having the form of an elongate strip and having multiple distinct medicament doses carried thereby, the method comprising
(a) loading said housing with the medicament carrier such that a leading end of said medicament carrier is drivably anchored within the housing and a trailing end of the medicament carrier hangs freely;
(b) drivably moving the leading end of the medicament carrier such as to move the medicament carrier fully into the housing; and
(c) coiling the medicament carrier in situ within the housing,
wherein the interior of the housing and/or components provided thereto are shaped to assist the in situ coiling of the medicament carrier.

41. A method according to claim 40, wherein the housing is provided with an access port through which medicament carrier may be loaded.

42. Housing for a medicament dispenser loaded with a coiled medicament carrier obtainable by a method according to claim 40.
